(19) United States
(12) Patent Application Publication
(10) Pub. No.: US 2020/0096470 A1
(43) Pub. Date: Mar. 26, 2020

(54) ELECTROCHEMICAL ASSAY FOR THE DETECTION OF OPIOIDS

(71) Applicant: Aalto University Foundation sr, Aalto (FI)

(72) Inventors: Niklas Wester, Aalto (FI); Elsi Mynttinen, Aalto (FI); Tomi Laurila, Aalto (FI)

(21) Appl. No.: 16/495,546

(22) PCT Filed: Mar. 22, 2018
(86) PCT No.: PCT/FI2018/050219

§ 371 Date: Sep. 19, 2019

(30) Foreign Application Priority Data
Mar. 22, 2017 (FI) 20175259

(51) Int. Cl. G01N 27/30; G01N 27/333; G01N 27/327

(52) U.S. Cl. CPC G01N 27/308; G01N 27/327; G01N 27/3335; G01N 27/301

(57) ABSTRACT

According to an example aspect of the present invention, there is provided multilayer test strip comprising a substrate onto which is deposited an electrode assembly layer comprising a carbon-based working electrode, a carbon-based counter electrode, a pseudoreference electrode, wherein the pseudo reference electrode, the working electrode and the counter electrode, are arranged adjacent to each other in the same plane, contacts for contacting the electrodes directly to a voltage supply, and the test strip further comprises a permselective membrane layer, said electrodes of the electrode assembly layer being electrically separated from one another and said electrode assembly layer being positioned between the substrate and the permselective membrane layer.

### CROSS-REFERENCE TO RELATED APPLICATIONS

This application is a National Stage application of International Patent Application No. PCT/FI2018/050219 filed on Mar. 22, 2018, which claims priority to Finnish Patent Application No. 20175259 filed Mar. 22, 2017, each of which is hereby incorporated by reference in its entirety.

### TECHNICAL FIELD

The present invention relates to a multilayer test strip, particularly a multilayer test strip for the detection of opioids and their metabolites in a sample and a method of manufacturing such a multilayer test strip. Further, the invention relates to a system for the detection of opioids and their metabolites comprising a multilayer test strip and a measurement circuit. Moreover, the present invention relates to a method for the measurement of opioids in sample.

### BACKGROUND

Morphine (MO), codeine (CO), tramadol (TR), oxycodone (OXY) and fentanyl (FEN) are widely used opioids for managing severe pain. These opioids are extensively used and highly effective analgesic agents for the treatment of acute and chronic pain. However, establishing efficacy of treatment while ensuring the safety of the patient is challenging due to individual pharmacokinetic and pharmacogenetic factors related to the use of opioids (FIG. 24).

These factors affect especially the use of prodrugs, such as CO and TR, that are partly or totally inactive at administration but are chemically converted into their active form within the body. CO is first metabolized by N-demethylation to norcodeine (NC) and further by O-demethylation to its active form MO, the pharmacologically active analgesic. MO and 6-acetylmorphine are also the main metabolites tested for in heroin drug testing. TR is similarly metabolized into its main active metabolite O-desmethyltramadol (ODMT). The metabolic activity of the enzyme responsible for the metabolism of both CO and TR, the hepatic enzyme CYP2D6, is highly individual and thus the analgesic effect of CO and TR ranges from no effect to high sensitivity. In addition, pharmacokinetic parameters (such as rate of excretion) of opioids that are active at administration are also highly individual.

The determination of concentration of opioids in samples is currently carried out using high performance liquid chromatography (HPLC) and liquid chromatography coupled with mass spectroscopy (LC-MS). Using these methods the inter-individual variability in the metabolism of opioids in humans, and in particular the activation of prodrugs can be detected and quantified. However, these methods are expensive and time consuming and therefore impractical in pain management as well as in differential diagnosis of opioid intoxication. Additionally, a highly skilled specialist is required to conduct the protocols and analyse the results.

Electrochemical detection methods have been found to be inexpensive, rapid and highly sensitive, as well as being relatively simple to operate. Such methods have been investigated for the detection of opioids in samples. However, due to very low therapeutic concentrations of opioids (e.g. the therapeutic concentrations of CO and MO range from tens to hundreds of nM depending on the dose; typically the therapeutic concentration is around the order of 100 nM and below) and due to the high concentrations (100-500 μM) of electroactive interferents such as ascorbic acid (AA) and uric acid (UA) in biological samples, selective quantitative detection of opioids is complicated and direct electrochemical detection is challenging. While detection of MO (Li 2010, Rezaei 2015, Dehdashtian 2016) and CO (Li 2013, Piech 2015) has been reported by several groups, few groups have reported simultaneous detection of MO and CO in the presence of interferents such as AA and UA (Li 2014, Ensafi 2015, Taei 2016). However, in these studies, the tolerance levels were reached already at lower levels of AA and UA than are expected to be found in e.g. blood samples.

Recently, carbon-based materials, such as amorphous carbon, carbon nanotubes (CNT) and various other forms of graphite, have attracted a great deal of attention, in particular for the use as novel electrode materials. Carbon materials have unique structure and extraordinary properties, such as large surface area, high mechanical strength, high electrical conductivity and electrocatalytic activity. While the electrocatalytic properties of these novel electrode materials have contributed greatly to the selectivity of voltammetric detection, the electrocatalytic properties of such carbon materials and surface treatments alone are not sufficient for total elimination of the above mentioned and possible other interferents in the electrochemical detection and quantitation of opioids.

Permselective membranes, such as Nafion, a sulfonated copolymer, are known in the art and have been used extensively due to antifouling and cation exchange properties, which provide for an increase in selectivity and long term signal stability in electrochemical measurements. Nafion membranes in particular have been shown to support fast electron transfer at reasonable scan rates. The hydrophilic negatively charged sulfonate groups enable pre-concentration of positively charged analytes and selective detections of cationic analytes. Since several interferents, such as AA and UA, exist as anionic molecules in solution (at neutral pH), their interference with the target analytes can be significantly reduced by a Nafion membrane as has been shown in numerous studies (Rocha 2006, Hou 2010, Ahn 2012). The Nafion membrane also shows size exclusion effect due to nano-sized hydrophilic channels, filtering out large molecules.

In addition to biomolecules, also other interfering anionic drug molecules (at physiological pH) coexist with opioids in biological samples. Especially non-steroidal anti-inflammatory drugs are present at high concentrations. The interference of these molecules can be eliminated with Nafion. In addition, the Nafion membrane presents a diffusion barrier that selectively enriches cations. For this reason, selectivity toward cations is also increased in the presence of neutral species, such as paracetamol, xanthine and hypoxanthine.

### SUMMARY

The invention is defined by the features of the independent claims. Some specific embodiments are defined in the dependent claims.

According to a first aspect of the present invention, there is provided a multilayer test strip comprising a substrate onto which is deposited an electrode assembly layer comprising a carbon-based working electrode, a carbon-based counter electrode, wherein the working electrode and counter electrode comprise the same carbon-based material, a pseudo-reference electrode, wherein the pseudo-reference electrode, the working electrode and the counter electrode, are arranged adjacent to each other in the same plane, contacts for contacting the electrodes directly to a voltage supply, and a permselective membrane layer, said electrode assembly layer being positioned between the substrate and the permselective membrane layer.

According to a second aspect of the present invention, there is provided an apparatus comprising a memory configured to store reference data, at least one processing core configured to process information from the strip described herein, compare the information from the strip described herein to the reference data, and draw conclusions on the information processed from the strip described herein.

According to a third aspect of the present invention, there is provided a method for detecting opioids in a sample comprising the steps of providing a sample, contacting the sample electrically with a working electrode (2) and counter electrode (4) of an electrode assembly of a multilayer test strip, changing voltage between the working electrode (2) and counter electrode (4) measuring a current between the working electrode (2) and counter electrode (4) as relation to the voltage applied between the working electrode (2) and counter electrode (4) and detecting a change in current characteristic of one or more opioid analytes in the sample.

### BRIEF DESCRIPTION OF THE DRAWINGS

FIG. 1 illustrates a method of fabricating an electrode in accordance with at least some embodiments of the present invention;

FIG. 2 shows the planar view and the cross section of press transferred CNT network on a glass substrate and coated with Nafion.

FIG. 3 illustrates an example apparatus capable of supporting at least some embodiments of the present invention,

FIG. 4 shows Cyclic voltammograms for CNT and CNT+Nafion electrodes in a) Fe(CN)₆^{4-/3-} in 1 M KCl, b) IrCl₆²⁻ in 1 M KCl, c) FcMeOH in 1 M KCl, d) FcMeOH in PBS, e) Ru(NH₃)₆^{2+/3+} in 1 M KCl and f) Ru(NH₃)₆^{2+/3+} in PBS. Scan rate 100 mV/s or 500 mV/s.

FIG. 5 shows differential pulse voltammograms for CNT and CNT+Nafion electrodes in a) 500 μM AA and UA and b) 50 μM MO and CO.

FIG. 6 shows differential pulse voltammograms for pristine and Nafion coated SWCNTN electrodes in 500 μM AA, 500 μM UA and c) 10 μM CO with increasing concentration of MO from 10 nM to 2.5 μM and d) 10 μM MO with increasing concentration of CO from 10 nM to 2.5 μM. Scan rate 50 mV/s.

FIG. 7 shows a) the thickness profile of a dip-coated Nafion film as measured from cross-sectional SEM-images (y-axis thickness in micrometers, x-axis measurement point over the full cross section, arbitrary distance). Measured cyclic voltammetry peak currents (for the oxidation and reduction peaks) as function of square root of scan rate for b) 1 mM IrCl₆ in 1M KCl, c) 1 mM FcMeOH in PBS with bare SWCNT-electrode, d) 1 mM FcMeOH in PBS with Nafion-coated SWCNT-electrode, e) 1 mM Ru(NH₃)₆ in 1M KCl with bare SWCNT-electrode, f) 1 mM Ru(NH₃)₆ in 1M KCl with Nafion-coated SWCNT-electrode. g) Cyclic voltammetry measurement in 1 mM Ru(NH₃)₆ in PBS with bare and Nafion-coated SWCNT-electrodes.

FIG. 8 shows a) the make up of an example sample for testing. The sample is made up of whole blood comprising plasma, white cells and platelets and red blood cells. The plasma portion in turn comprises a challenging matrix of analytes including AA (50-200 μmol/l), UA (100-500 μmol/l), ibuprofen (˜100 μmol/l), aspirin (˜100 μmol/l), paracetamol (˜100 μmol/l) and MO (1-100 nmol/l). FIG. 8b) shows the passive filtering of the whole blood sample, filtering out e.g. red cells, white cells and platelets, allowing proteins, anions and cation analytes to pass over the filter, cation analytes then pass over the permselective membrane, which prevents the passage of neutral and anionic components. This results in cation analytes only contacting the working electrode of the testing strip.

FIG. 9 is a scanning electron micrograph of a cross section of an electrode according to at least some embodiments of the invention. What is shown is a SWCNTN deposited on a glass substrate and a layer of Nafion, a permselective membrane, coating the SWCNTN.

FIG. 10 shows a) differential pulse voltammograms of different concentrations of paracetamol (PA) in the presence of 500 uM AA and 500 uM UA measured with a SWCNT-electrode coated with 5% Nafion solution (dip coating in solution for 5 s), b) differential pulse voltammograms of different concentrations of morphine (MO) and codeine (CO) in phosphate buffered saline (PBS) measured with a SWCNT-electrode coated with 5% Nafion solution (dip coating in solution for 5 s), c) differential pulse voltammograms of different concentrations of MO in the presence of 500 uM AA, 500 uM UA and 10 uM CO and the two linear ranges of peak currents as a function of concentration for MO, d) a close-up of FIG. 10c) for the smaller concentrations of MO, e) differential pulse voltammograms of different concentrations of MO measured in undiluted pooled plasma and a close-up of the smaller concentrations.

FIG. 11 illustrates a test strip according to at least some embodiments of the invention as well as an electrochemical reaction of an analyte (oxidation of MO), which is the result of passing an electrical current through the analyte, which in turn results in a signal for the analyte (MO) in a voltammogram. The test strip shown comprises an electrode assembly (1) onto which is deposited a cation exchange membrane (11), which is a permselective membrane, such as nafion, a filter (10) for the passive filtering of a sample to be analysed and a protective hydrophobic membrane (9), e.g. a Teflon membrane.

FIG. 12 describes an electrode assembly (1) for use in the test strip according to at least some embodiments of the invention. The electrode assembly (1) comprises a working electrode (2), a counter electrode (4) and a pseudo reference electrode (3). The working electrode (2) is a Titanium/tetrahedral amorphous carbon (Ti/taC) electrode. The pseudo reference electrode (3), and the counter electrode (4) is formed from silver. The electrodes are positioned electrically separated from each other (8) in the same plane, and the working electrode (2) is positioned between the pseudo reference electrode (3) and the counter electrode (4). Each electrode (2, 3, 4) is provided with a contact (5, 6, 7) for direct connection to a voltage supply. The contacts (5, 6, 7) are typically made of silver, e.g. silver paint.

FIG. 13 shows differential pulse voltammetry measurements of some opioids and common interferents with a Ti/taC electrode. Illustrative figure depicting oxidation peak position, measured currents not to scale.

FIG. 14 shows differential pulse voltammetry measurements of some opioids with SWCNT electrodes.

FIG. 15 shows differential pulse voltammograms of a) MO and b) CO with plain and Nafion coated SWCNT electrodes. Using the Nafion membrane increases the selectivity as well as the sensitivity of the SWCNT electrodes for both MO and CO.

FIG. 16 shows measured DPV signals as a function of retention time in 10 μM solutions of MO and CO.

FIG. 17 shows DPV scans of morphine-3-glucuronide (M-3-G) with a) a plain SWCNT electrode and b) a Nafion coated SWCNT electrode.

FIG. 18 shows DPVs of several concentrations of a) tramadol (TR) and b) O-desmethyltramadol (ODMT) in separate solutions and c) 50 μM TR and 50 μM ODMT in the same solution measured with a Ti/ta-C electrode without Nafion, and d) 50 μM TR and 50 μM ODMT in the same solution measured with a Ti/taC electrode coated with Nafion.

FIG. 19 shows DPVs of AA and UA with plain and Nafion coated SWCNT electrodes.

FIG. 20 shows DPVs of 50 μM a) xanthine (Xn) and b) hypoxanthine (HXn) with plain and 2.5% coated Ti/taC electrodes.

FIG. 21 shows DPV measurements of undiluted plasma with plain SWCNT electrode (black) and Nafion coated SWCNT electrode (grey).

FIG. 22 shows DPVs of undiluted human plasma spiked with increasing concentration of morphine with a Nafion coated SWCNT electrode.

FIG. 23 shows DPV measurement of 50 μM ketamine.

FIG. 24 illustrates the changes in blood concentration of a given opioid between doses.

FIG. 25 shows a number of electrode assemblies according to at least some embodiments of the invention. Each electrode assembly (1) comprises a working electrode (3) a reference electrode (4) and a counter electrode (2). Each electrode is provided with three contacts (5, 6, 7) for connecting directly to an external voltage supply.

FIG. 26 shows a test strip according to at least some embodiments of the invention comprising a working electrode (2) made of a carbon-based material, a counter electrode (4) made of a carbon-based material, a pseudo reference electrode (3) made of silver and contacts (5, 6, 7) for connecting the electrodes (2, 3, 4) directly to an external voltage supply.

FIG. 27 shows a test strip electrode assembly according to at least some embodiments of the invention comprising a working electrode (3) made of a carbon-based material, a counter electrode (2) made of a carbon-based material, a pseudoreference electrode (4) made of silver and contacts (5, 6, 7) for connecting the electrodes directly to an external voltage supply. Also shown is an electrode assembly with dimensions shown in mm.

FIG. 28 shows a) differential pulse voltammetry measurements of 50 uM MO (a) and 50 uM CO (b) with a bare SWCNT-electrode and a Nafion-coated SWCNT-electrode. This figure illustrates how the Nafion membrane reduces the number of peaks for opioid analytes, thus further increasing the selectivity.

FIG. 29 shows differential pulse voltammetry measurements in PBS, 50 uM morphine-3-glucuronide (M3G) and 100 uM M3G with a) bare SWCNT-electrode and b) SWCNT with Nafion. The Nafion membrane efficiently filters out the inactive metabolite of MO.

FIG. 30 The effect of cathodic conditioning of the working electrode in detecting fentanyl.

FIG. 31 shows differential pulse voltammograms of different concentrations of morphine (MO) and codeine (CO) in phosphate buffered saline (PBS) measured with a SWCNT-electrode coated with 5% Nafion solution (dip coating in solution for 5 s). The linear range of peak current vs. concentration of CO in addition to that of MO is also shown.

FIG. 32 shows differential pulse voltammograms of different concentrations of MO in the presence of 500 uM AA, 500 uM UA and 10 uM CO and the two linear ranges of peak currents as a function of concentration for MO and CO

### EMBODIMENTS

To establish individual pharmacokinetic and pharmacogenetics factors it is important to be able to simultaneously quantitatively measure the blood concentration of opioids of a patient. In the case of determining metabolically produced MO from CO and heroin, especially morphine has to be measured accurately. The electrode utilized in this work can be seen to repeatably measure currents for 50 nM morphine in the presence of AA, UA and CO, the peak currents of MO producing two linear ranges. The lower range is well within the therapeutic concentrations for treatment of pain and also for most cases of intoxication, and poisoning.

Thus, it is an aim of embodiments to overcome at least some of the disadvantages mentioned above and provide a multilayer test strip for the detection of opioids in a sample. In an embodiment the multilayer test strip comprises a substrate onto which is deposited an electrode assembly layer comprising a carbon-based working electrode, a carbon based counter electrode, a pseudoreference electrode, contacts for contacting the electrodes directly to a voltage supply and a permselective membrane. In an embodiment the pseudoreference electrode, the working electrode and the counter electrode are arranged adjacent to each other in the same plane. In one embodiment the electrodes forming the electrode assembly layer are electrically separated from one another. In a further embodiment the working electrode and the counter electrode comprise the same carbon-based material. In a still further embodiment, the counter electrode is formed of the same material as the reference electrode. In a preferred embodiment, the counter electrode and reference electrode are formed from a material that is different to the material forming the working electrode. In one embodiment the carbon-based material comprised in the working electrode is different from the carbon-based material comprised in the counter electrode. In an embodiment the electrode assembly layer is positioned between the substrate and the permselective membrane layer.

The permselective layer provides intrinsic permselective properties, i.e. anion interferents such as UA and AA and neutral interferents such as xanthine (Xn) and hypoxanthine (HXn) are blocked and not allowed to pass from a sample to the electrodes. With such a test strip electrochemical detection of opioids can be carried out with cyclic voltammetry (CV), linear sweep voltammetry (LSV), normal pulse voltammetry, square-wave voltammetry, differential pulse voltammetry (DPV), adsorptive stripping voltammetry, chronocoulometry and chronoamperometry.

In one embodiment the carbon-based electrodes comprise carbon selected from the group consisting of amorphous carbon, such as tetrahedral amorphous carbon, diamond like carbon, graphite, carbon nanotubes and a mixture thereof. In a further embodiment the carbon-based electrodes comprise a single walled carbon nanotube network (SWCNTN). SWCNTN are highly conductive and can be used to fabricate wires and can be contacted directly to a voltage supply. For example, thin films can be patterned to make conductive lines and electrodes, which may be wires.

Opioids and most other bio and drug molecules are so called inner sphere analytes, meaning that they are sensitive to the surface chemistry of the electrode materials. Hence, the oxidation potential and sensitivity may be tuned by changing the carbon-carbon bonding and surface functional groups. Similarly, surface metallic catalysts used to synthesize carbon nanomaterials also affect the electrochemical properties. Controlling the surface loading of these catalyst metals and their oxidation states can also be used to increase selectivity. Thus, in an embodiment one or more of the carbon-based electrodes further comprise one or more catalytic metals. In a preferred embodiment one or more of the carbon-based electrodes comprise titanium.

As mentioned above the electrode assembly is deposited on a substrate. In an embodiment the substrate is selected from the group consisting of polymer and glass. Polymer/Glass substrates provide inexpensive disposable test strips.

As well as a working electrode and a counter electrode, the test strip further comprises a pseudoreference electrode, sometimes called a quasi-reference electrode. A working electrode is the electrode in an electrochemical system on which a reaction of interest takes place. A counter electrode is an electrode that serves merely to carry the current flowing through an electrochemical cell. A pseudo-reference electrode is an electrode through which no appreciable current is allowed to flow and is used to observe or control the potential at a working electrode. In an embodiment the pseudoreference electrode comprises silver. In a preferred embodiment, the pseudo-reference electrode comprises silver-silver chloride (Ag/AgCl). In a particular embodiment the pseudo-reference electrode comprises platinum.

In embodiments the permselective membrane layer comprises a permselective membrane selected from the group of polymers consisting of Nafion, cellulose acetate, conventional dialysis membranes, polyvinyl sulfonate, carboxymethyl cellulose, polylysine, overoxidised polypyrrole and other sulfonated polymers. Commonly used polymer films such as Nafion exhibit size exclusion, charge exclusion, ion exchange, complexing, catalytic and conducting properties. In a preferred embodiment the permselective membrane comprises Nafion.

Extensive cyclic voltammetry (CV) and differential pulse voltammetry (DPV) results have been carried out with electrodes coated with a Nafion membrane. CV results with various redox probes with both positive and negative charge can be found in the manuscript attached to the provisional patent. The results show that negatively charged ferricyanide Fe(CN)₆ and iridiumchloride IrCl₆ are excluded by the Nafion coating, while cationic hexaammineruthenium Ru(NH₃)₆ and ferrocenemethanol FcMeOH are enriched under the membrane. These results have confirmed the known permselective properties of Nafion.

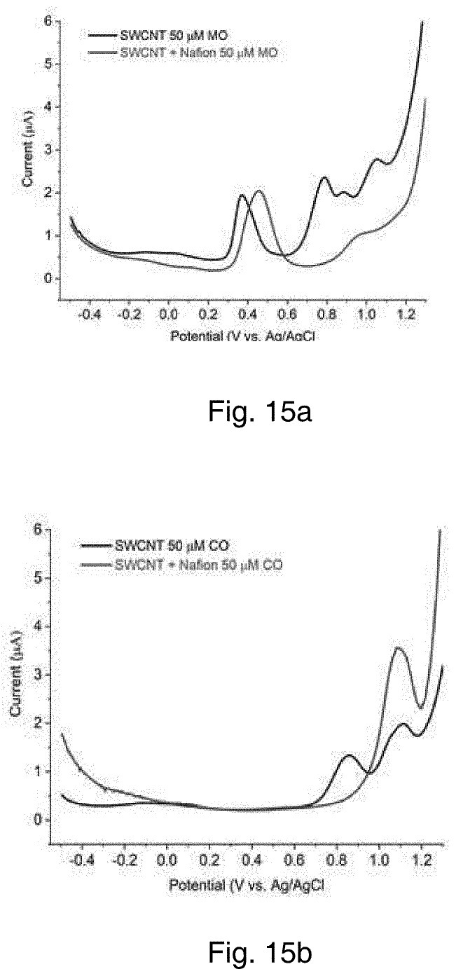

DPV experiments carried out with Nafion coated SWCNT electrodes in morphine (FIG. 15a) and codeine (FIG. 15b) solutions show that the Nafion coated electrode sees fewer peaks for both morphine and codeine, thus increasing the selectivity of the electrode. The selectivity for morphine is especially increased by the significant reduction in the current or total disappearance of the higher potential peaks, enabling simultaneous detection of morphine and codeine. It can further be seen that the Nafion coating enhances the signal of morphine and especially that of codeine. This is probably due to increased concentration under the film due to the Gibbs-Donnan effect. The manuscript in the provisional patent shows that it is possible to simultaneously detect morphine and codeine in nanomolar concentrations.

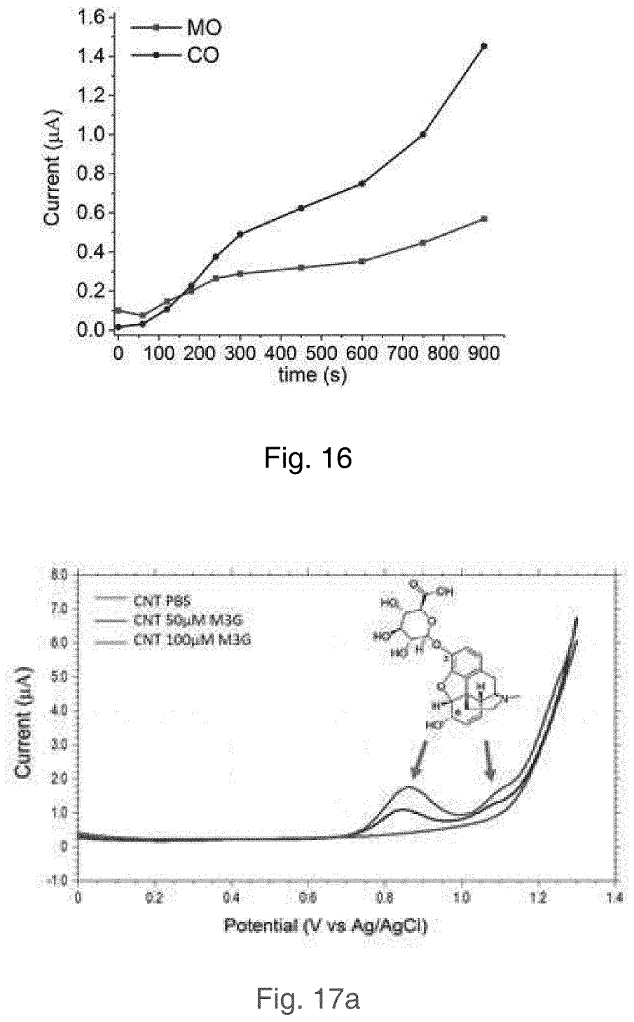

The enrichment as a function of retention time (the time between bringing the electrode in contact with the solution and starting the measurement) was further studied in a solution with 10 μM concentrations of morphine and codeine. FIG. 16 shows the measured currents as a function of retention time and clearly demonstrates the increase in the signal current for both morphine and codeine with the retention time.

The Nafion membrane is also predicted to be useful in inhibiting interference from some opioid metabolites present in real samples. Some measurements have already been done with metabolites of morphine and additional measurements are planned to be conducted with metabolites of oxycodone.

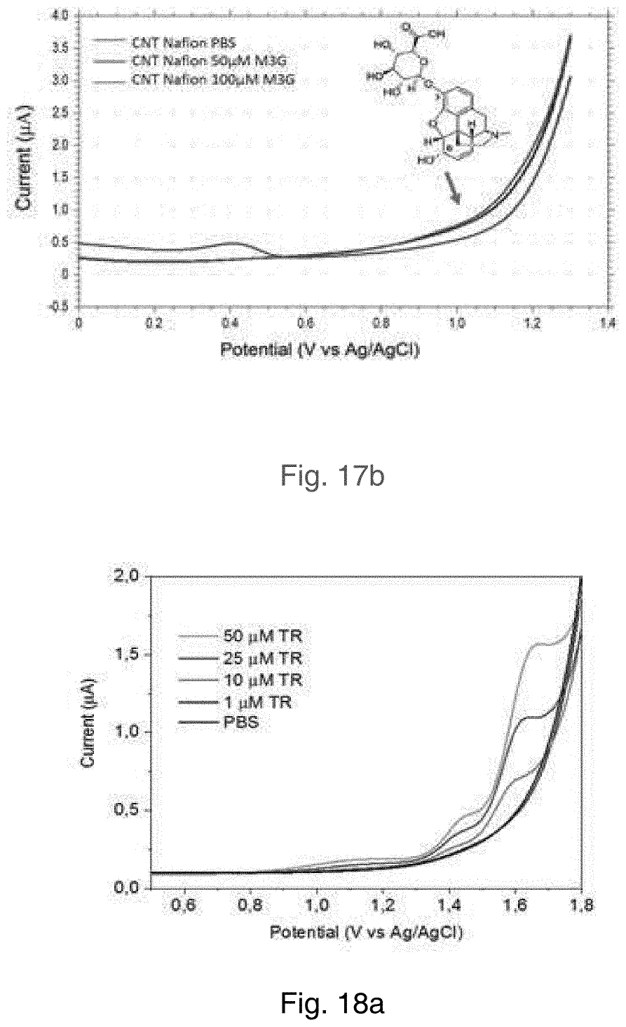

The main metabolites of morphine are glucuronides, which are produced by a coupling of a glucuronide to carbon 3 or 6. Morphine-6-glucuronide (M-6-G) is a major active metabolite of morphine, while morphine-3-glucoronide (M-3-G) is not an active opioid agonist. FIG. 17 shows the measurement of M-3-G with and without Nafion coating. It can be seen that M-3-G cannot permeate the Nafion membrane. It is expected that morphine glucuronides, and glucuronides in general cannot permeate the membrane, inducing increased selectivity toward morphine.

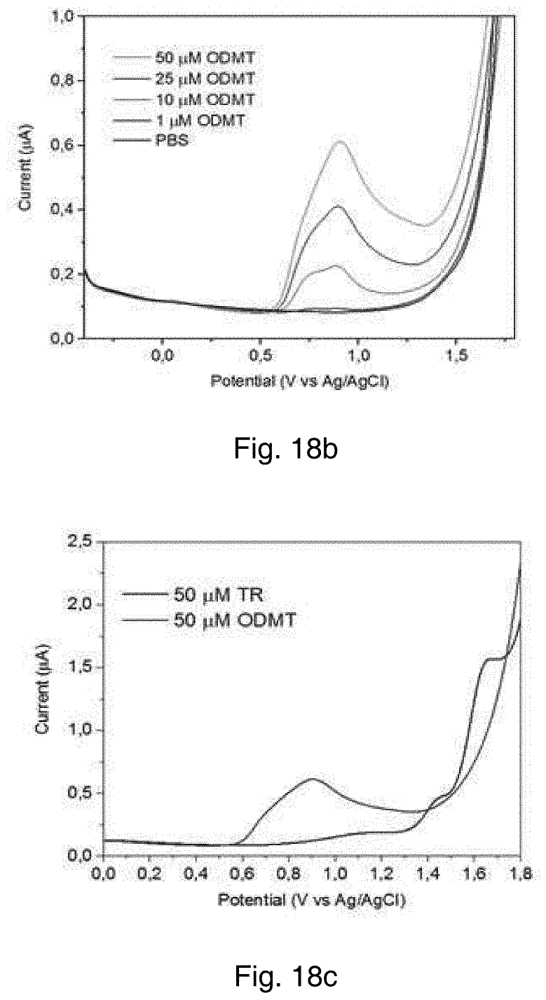

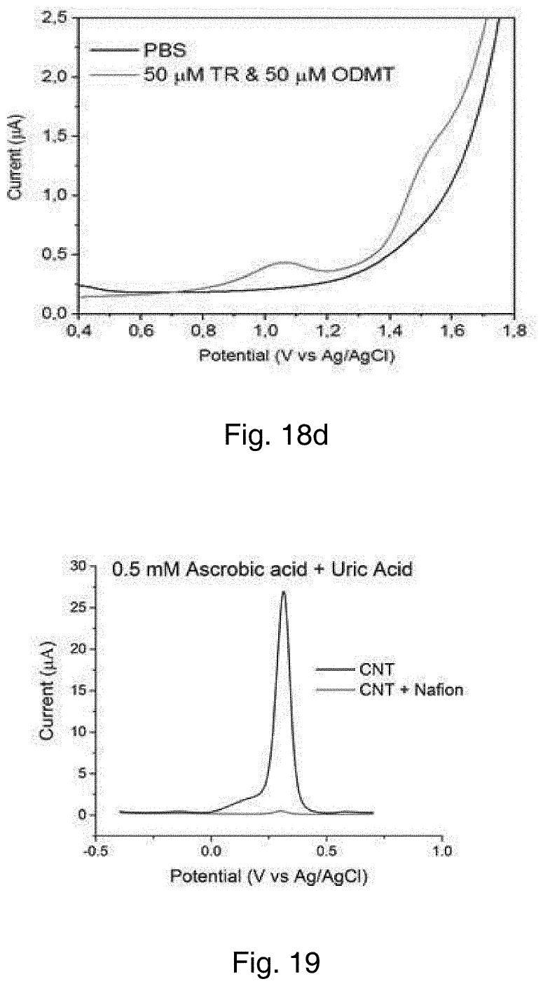

The effect of Nafion coating in selective and sensitive detection of opioids can also be seen in experiments with tramadol (TR) and its main metabolite O-desmethyltramadol (ODMT). In FIG. 18, these two analytes are measured with a tetrahedral amorphous carbon (ta-C) electrode with and without Nafion coating. While the plain ta-C electrode is able to see both TR and ODMT separately (FIGS. 18a and 18b, respectively), they both exhibit several oxidation peaks and thus cannot be measured from the same solution (FIG. 18c).

In contrast, by coating the electrode with a Nafion membrane, only one peak for each analyte is registered, and thus TR and ODMT can be selectively detected from the same solution (FIG. 18d). Currently, no such result can be found in the literature. However, the oxidation potential of tramadol varies significantly with different electrode materials. For example, according to some preliminary results, with SWCNT-electrodes the signals for TR and ODMT overlap. Thus, it is possible that some studies measuring tramadol form real biological samples may in fact be measuring a superimposition of tramadol and O-desmethyltramadol.

The Nafion coating, being a cation exchange membrane, further increases selectivity by blocking negatively charged species, such as ascorbic acid (AA) and uric acid (UA) from reaching the electrode. FIG. 19 shows the DPVs of plain and Nafion coated SWCNT electrodes in AA and UA solutions.

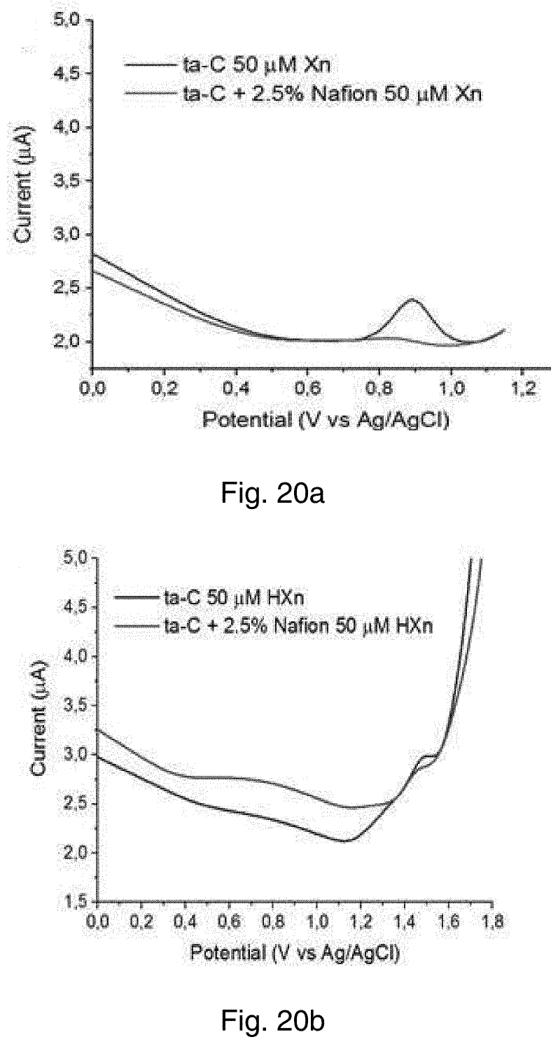

The interference caused by other biomolecules with neutral charge at physiological pH, such as xanthine and hypoxanthine (FIG. 20), have also been studied with ta-C electrodes. The Nafion coating also seems to reduce the interference of these molecules.

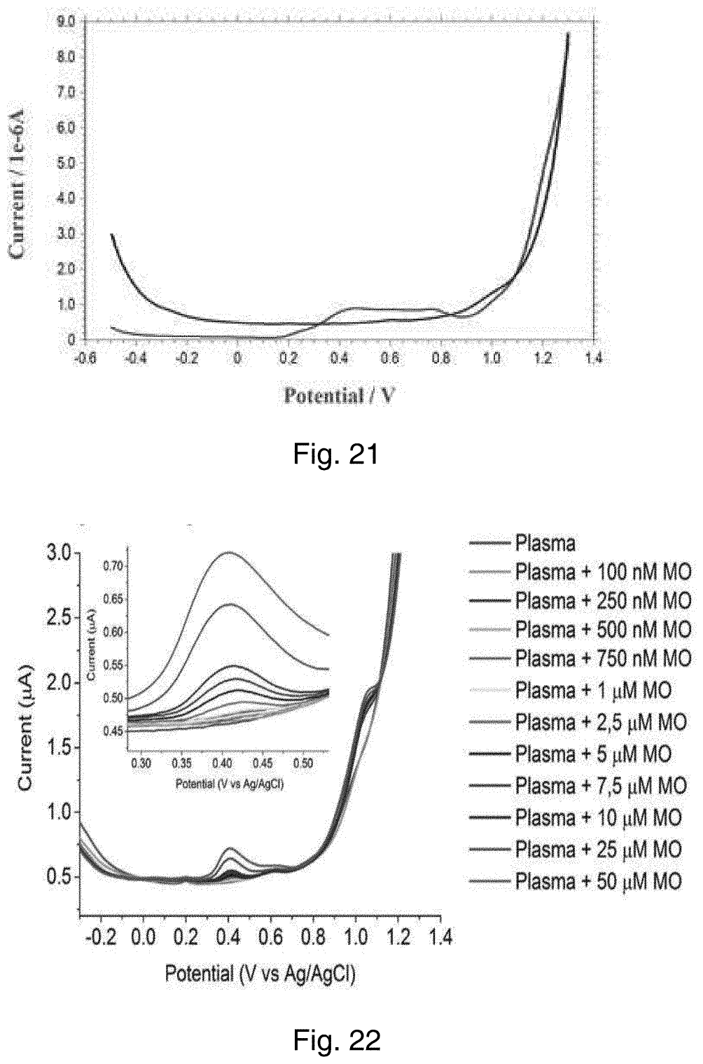

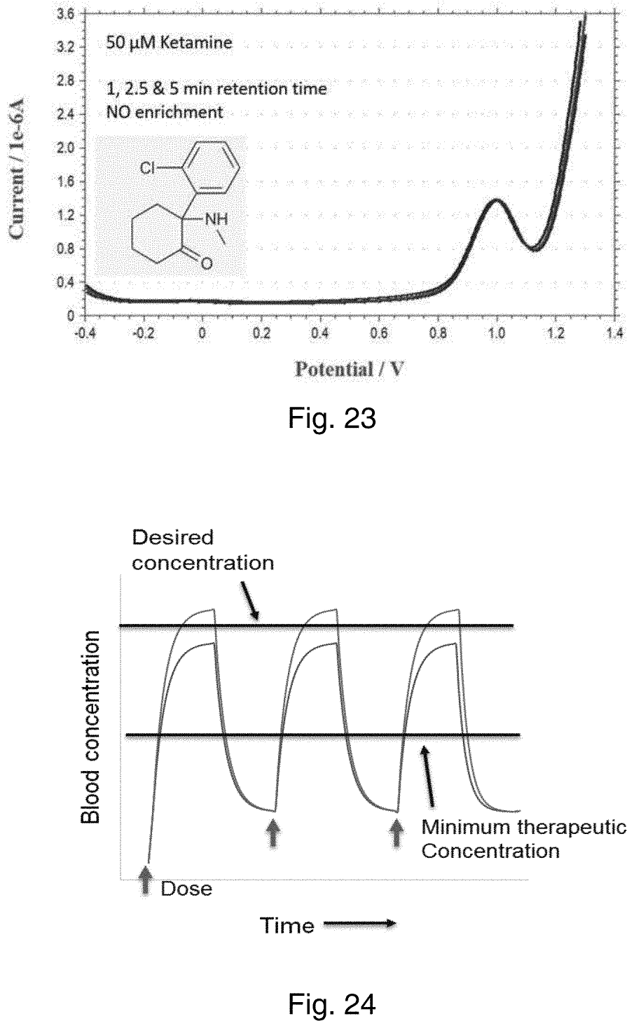

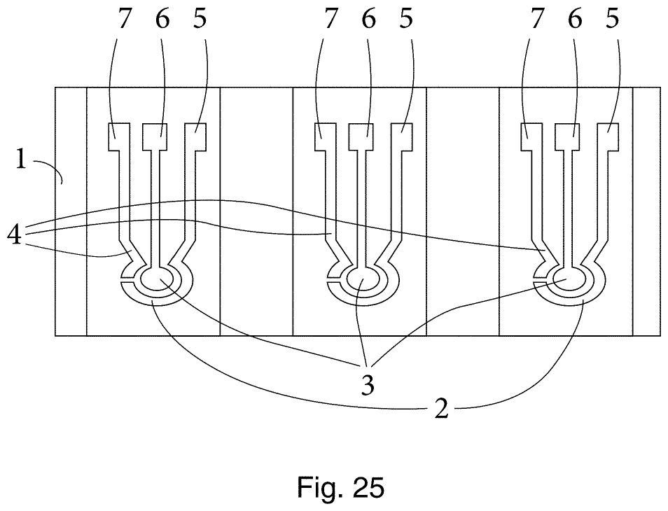

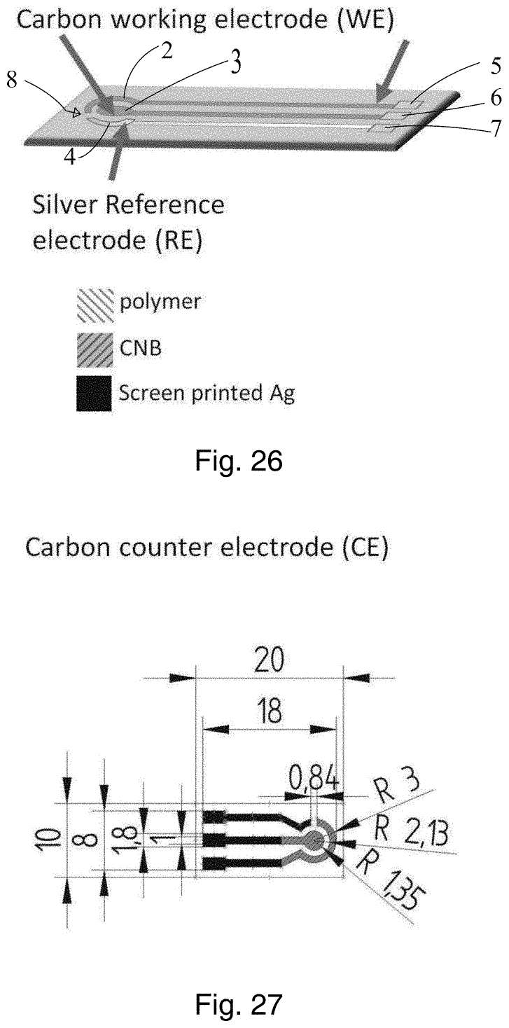

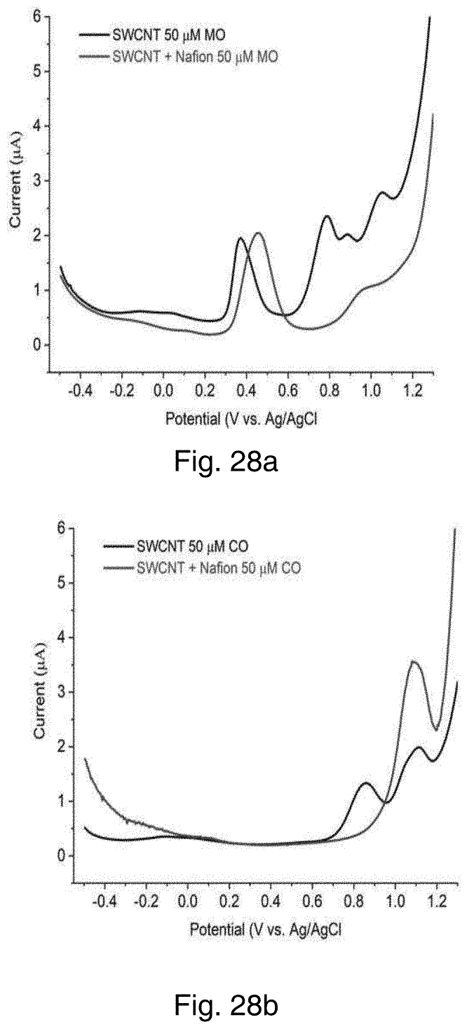

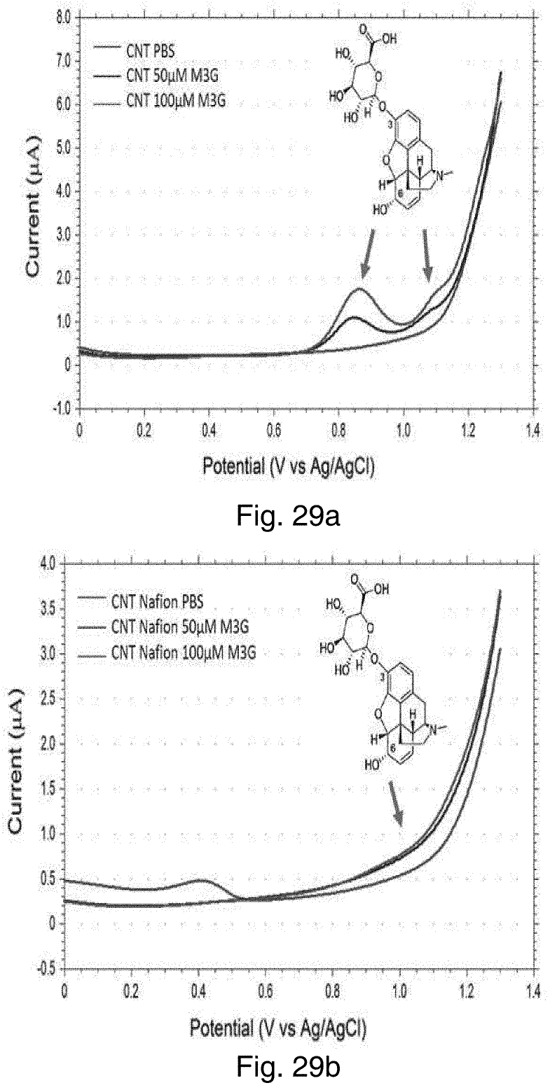

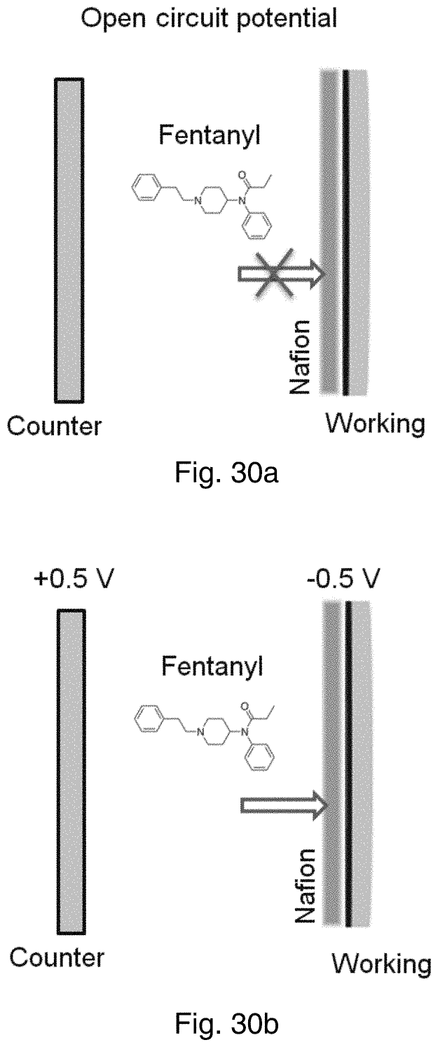

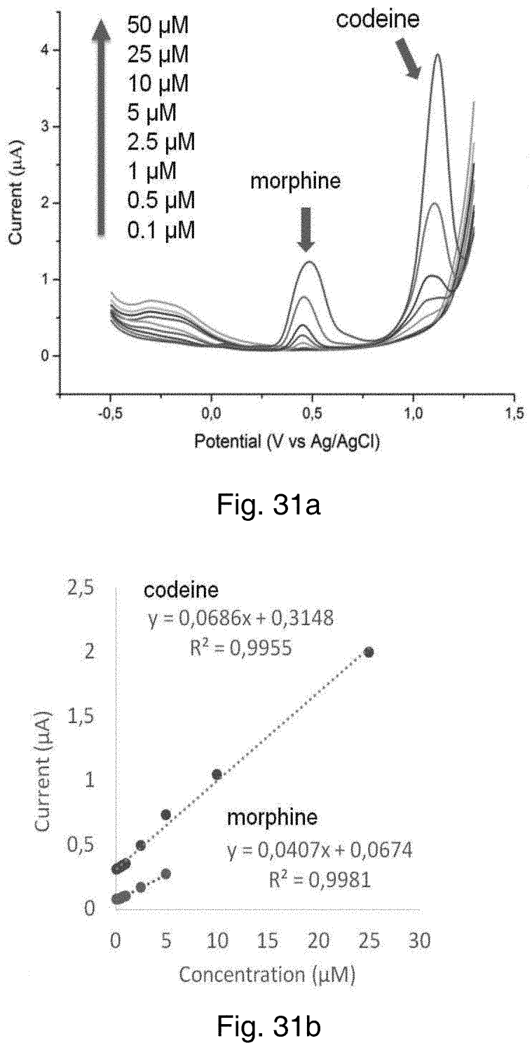

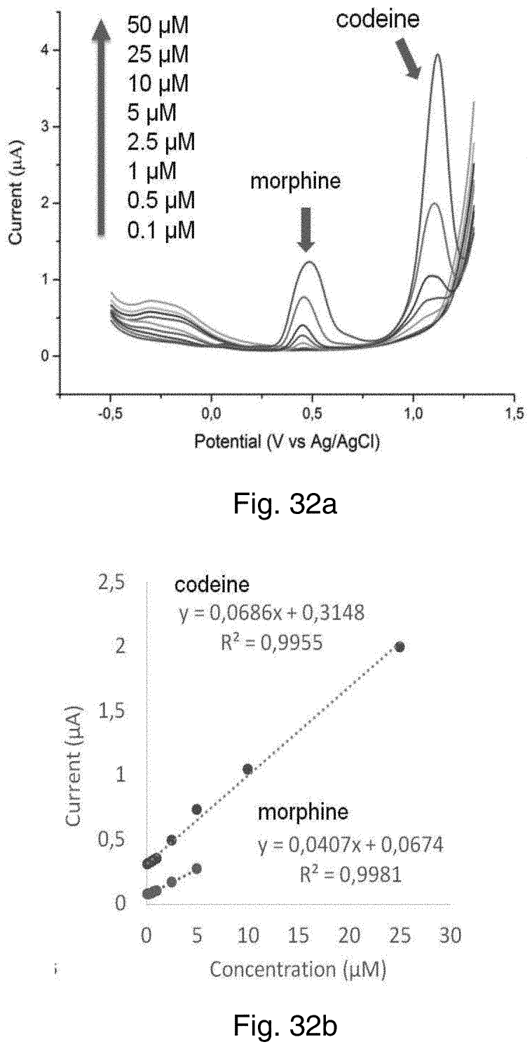

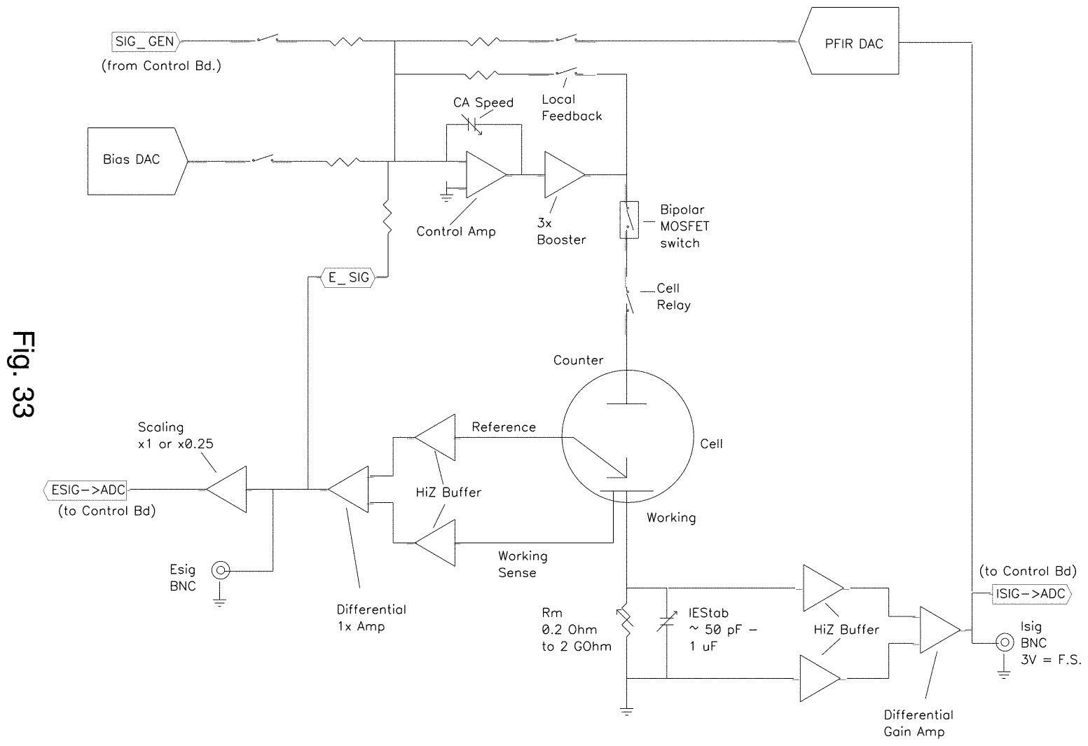

Experiments have also been carried out with real human plasma samples. The initial experiments shown in FIG. 21 indicate that the Nafion coating can effectively limit the interference of interfering species in the plasma sample. FIG. 22 further shows that it is possible to detect morphine in an undiluted human plasma sample after spiking with different concentrations of morphine.

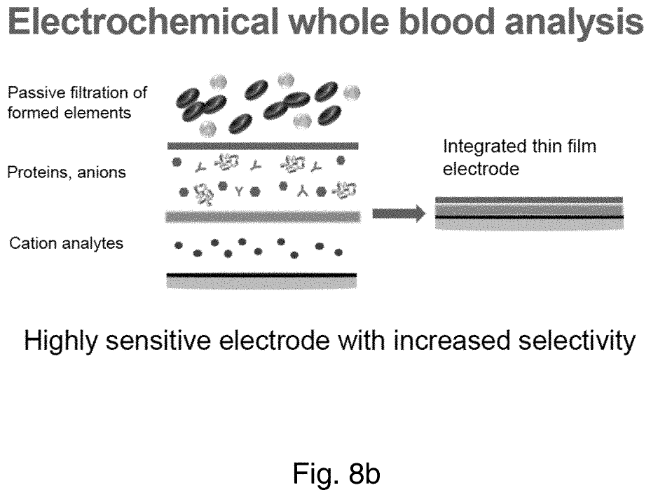

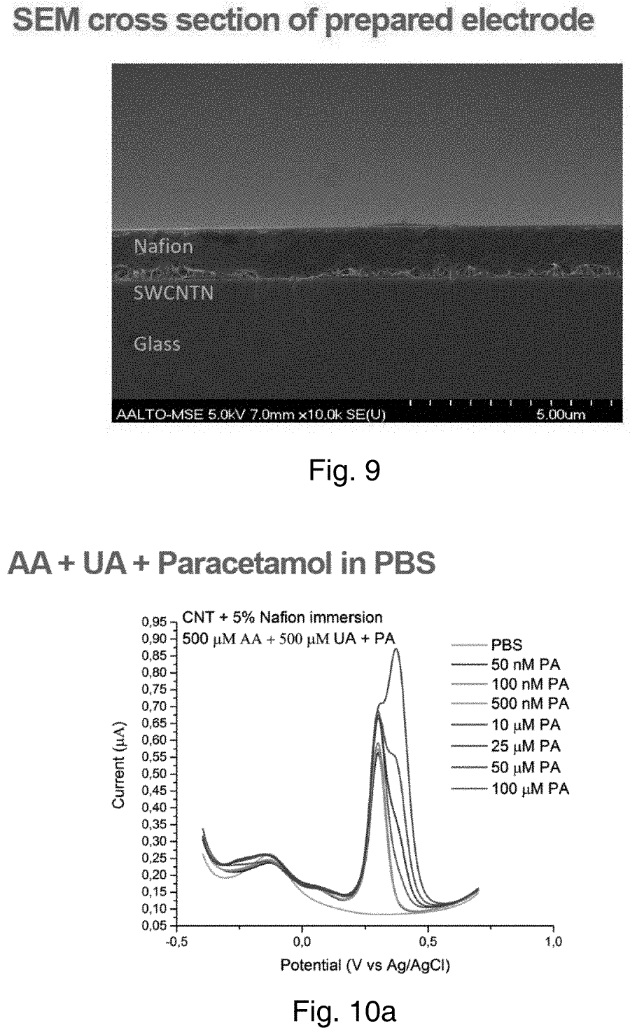

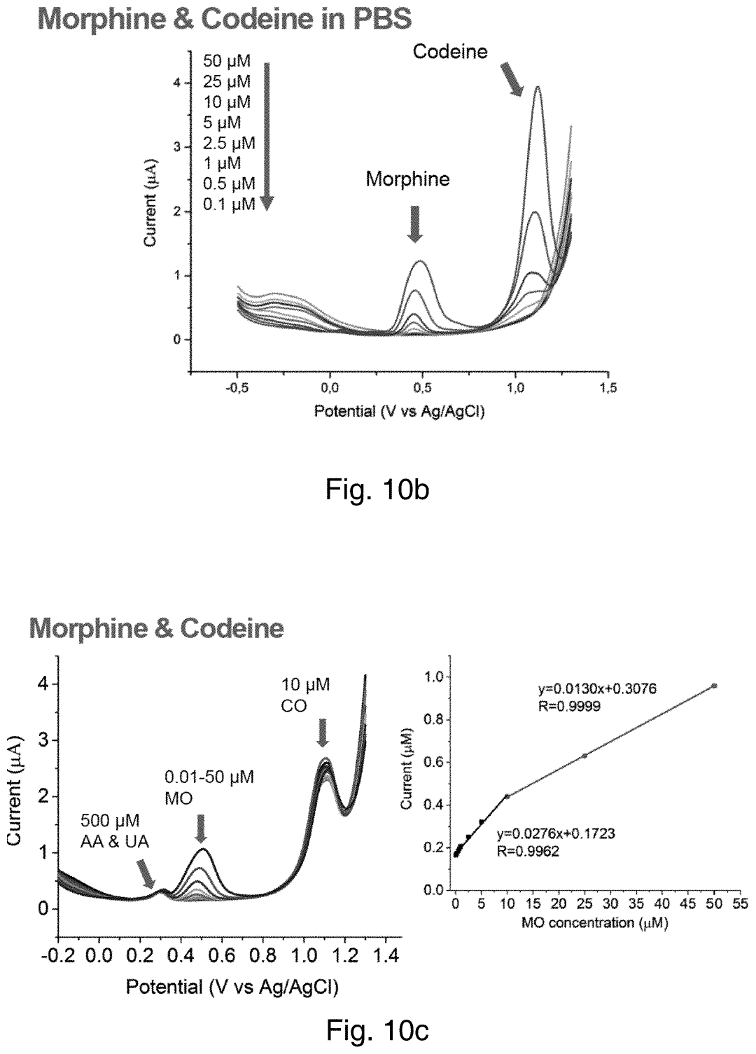

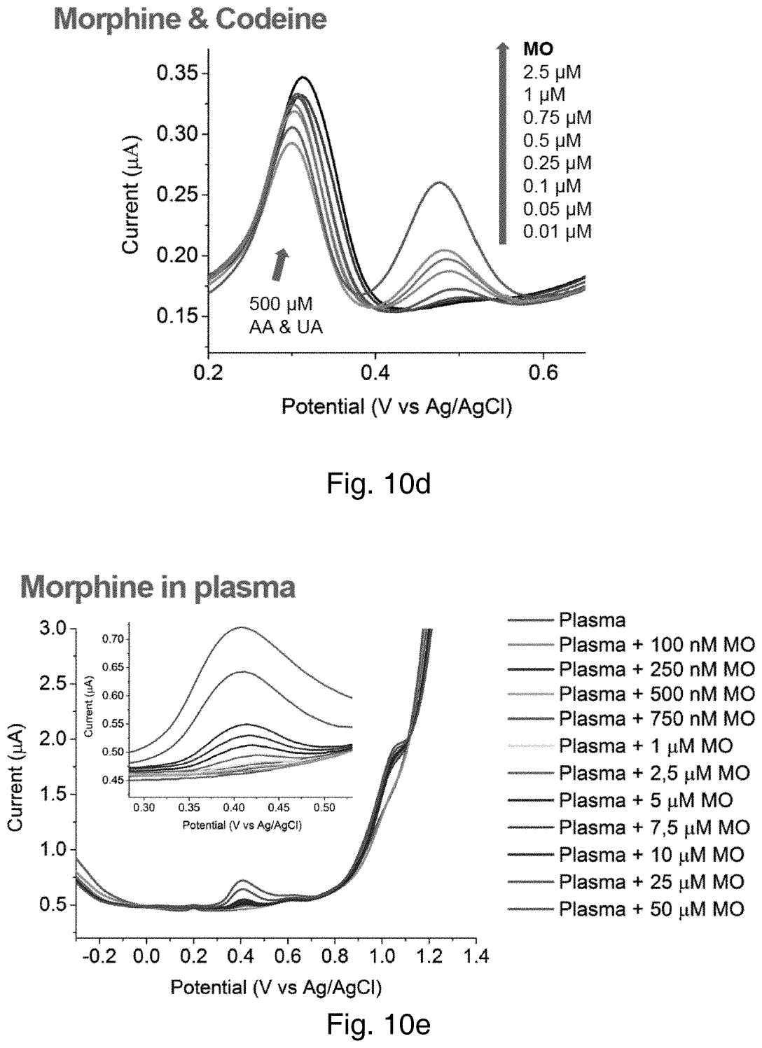

In further embodiments, the strip further comprises a filter layer. The filter layer is provided to passively filter blood formed elements (blood cells) from whole blood samples provided for assay (FIG. 8). In an embodiment, the strip is arranged so that the permselective membrane layer is positioned between the filter layer and the electrode assembly layer.

Further embodiments of the strip further comprise a hydrophobic membrane/film layer. In one embodiment the strip is arranged so that the filter layer is positioned between the permselective membrane layer and the hydrophobic membrane/film layer. In a further embodiment the hydrophobic membrane/film layer comprises Teflon. The hydrophobic membrane/film layer is present as a protective layer.

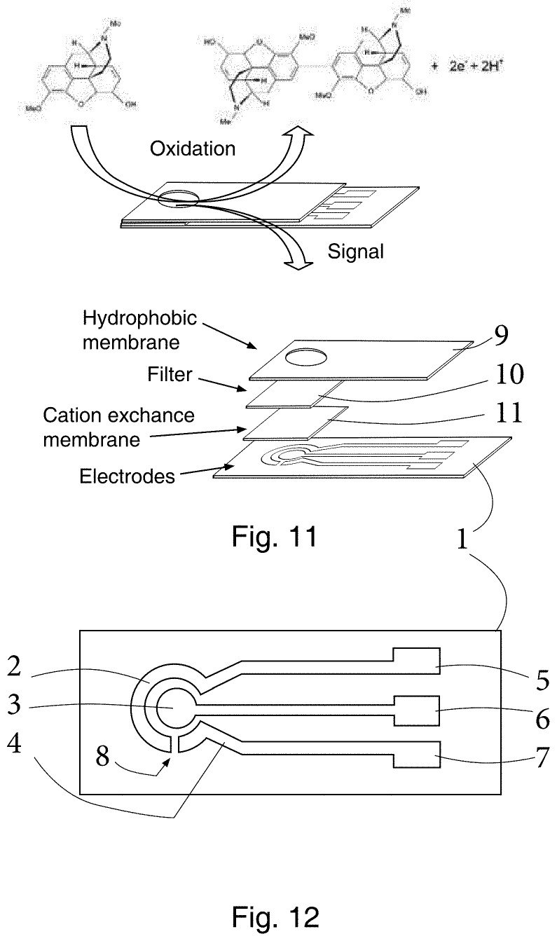

In one embodiment is provided a multilayer electrode that comprises a filter capable of passive filtration of blood formed elements (blood cells), cation exchange membrane and carbon electrode, a permselective membrane, that shows both size and charge exclusion, a carbon-based electrode, such as carbon nanotubes, amorphous carbon or graphite. Opioids and most other bio- and drug molecules are so called inner sphere analytes, meaning that they are sensitive to the surface chemistry of the electrode materials. Hence, the oxidation potential and sensitivity may be tuned by changing the carbon-carbon bonding and surface functional groups. Similarly, surface metallic catalysts used to synthesize carbon nanomaterials also affect the electrochemical properties. Controlling the surface loading of these catalyst metals and their oxidation states can also be used to increase selectivity and selectivity. In the case of opioids, which are predominantly positively charged under physiological conditions (i.e., cations), the permselective membrane layer consists of a cation permselective membrane, such as Nafion. This increases selectivity as opioids are enriched under the membrane and the membrane blocks negatively charged anions, such as ascorbic acid and uric acid, present in large concentrations in biological fluids (see FIGS. 11 and 12).

Thus, in embodiments is provided a test strip with working, counter and pseudo-reference electrodes for analysing small volumes (10-60 μl) of blood samples drawn with finger prick kits. FIG. 11 shows how such an electrode will detect morphine by electrochemically oxidising it. A test strip with Ti/ta-C working electrode and silver counter and reference electrodes is shown in FIG. 12.

The test strip is useful for the detection of free morphine in undiluted plasma/blood. The test strip can be designed to detect only hydroxyls or hydroxyls and amines allowing the detection of several opioids with some selectivity, such as the simultaneous selective detection of morphine and codeine. Further, the detection of metabolically produced active metabolites morphine (from codeine) and o-desmethyltramadol (from tramadol) is also enabled. And as is described below, the test strip provides for the discrimination of glucoronides. As seen from the differences between the ta-C electrodes and SWCNT, the electrochemical oxidation potential is highly dependent on surface chemistry. Previous characterization has shown that the SWCNT is graphitic with low concentration of defects and oxygen containing groups whereas the ta-C has a diamond-like bulk and amorphous sp2-rich surface layer. These types of differences can be used through electrode material selection or surface functionalization treatments to tailor the selectivity and sensitivity of the test strip.

The test strip provides information on the content of samples that are tested. Embodiments of the invention thus relate to an apparatus for analysing the information provided by the test strip. Thus, in an embodiment is provided an apparatus comprising a memory configured to store reference data, at least one processing core configured to process information from the strip according to any one of the above described embodiments. compare the information from the strip according to any of the above described embodiments to the reference data, and draw conclusions on the information processed from the strip according to any one of the above described embodiments.

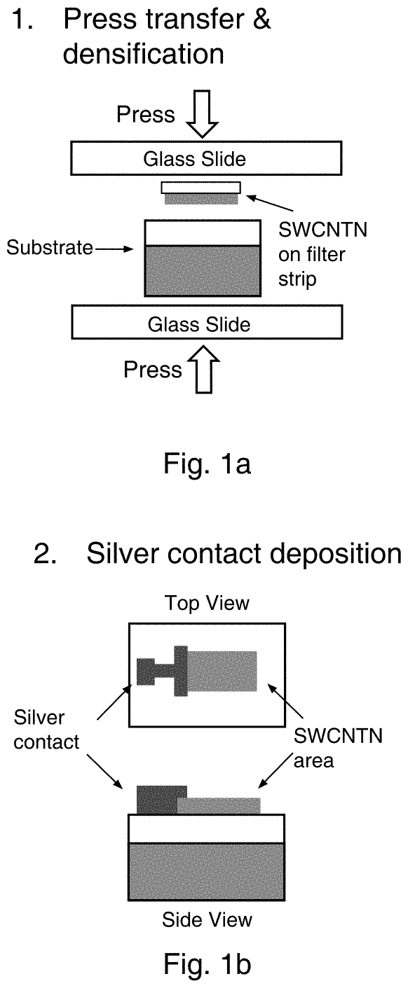

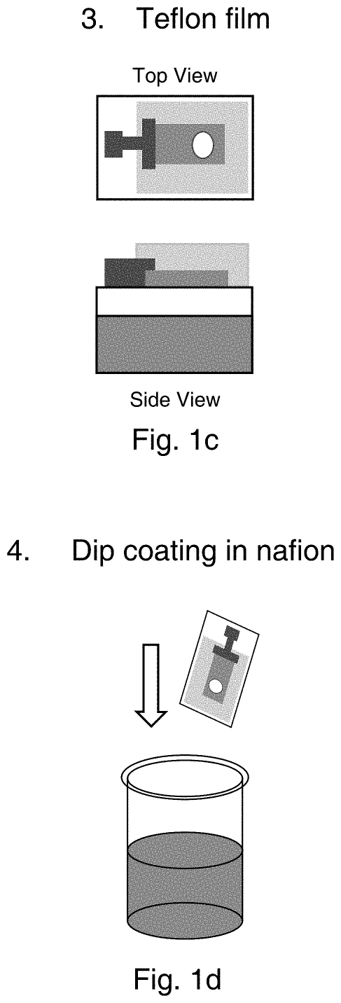

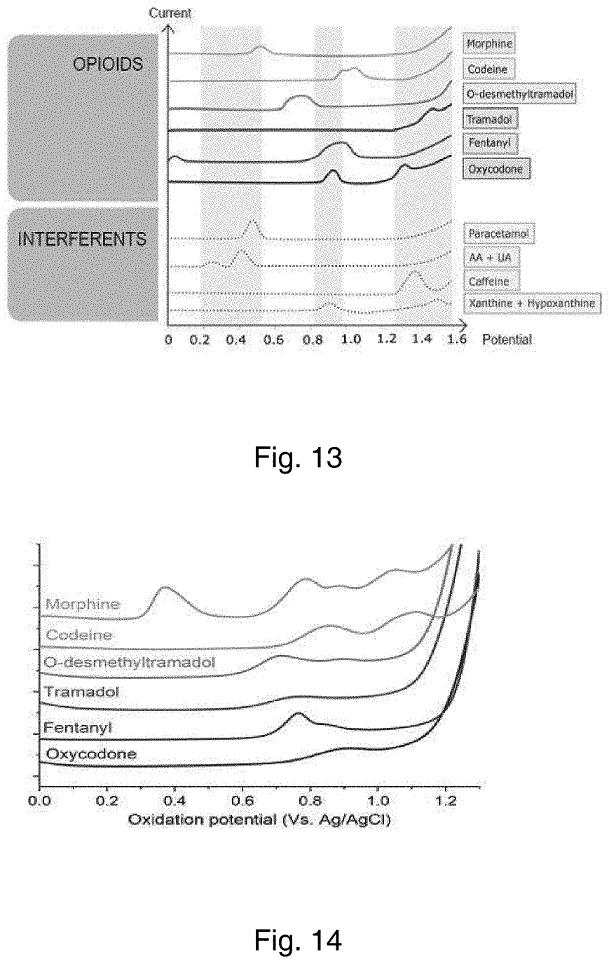

As mentioned above, the test strip is particularly useful for the detection of opioids. Several opioids have been measured in phosphate buffer solution (PBS) with these multilayer electrodes described above and shown in FIG. 1. The carbon materials used in these measurements have been tetrahedral amorphous carbon deposited on top of titanium (Ti/ta-C) and single walled carbon nanotubes (SWCNT). The results show some variation in both sensitivity and position of oxidation potentials. Most of the measured opioids also display several oxidation peaks attributed to oxidation of hydroxyl groups and amine groups. FIG. 13 shows the measurements of several opioids as well as some common interferents with Ti/ta-C electrode. The measurements of the same opioids with SWCNT electrodes is shown in FIG. 14.

Thus, embodiments of the invention relate to a method of detecting opioids in a sample. In an embodiment the method comprise the steps of providing a sample, contacting the sample electrically with a working electrode (2) and counter electrode (4) of an electrode assembly of a multilayer test strip, changing voltage between the working electrode (2) and counter electrode (4) measuring a current between the working electrode (2) and counter electrode (4) in relation to the voltage applied between the working electrode (2) and counter electrode (4) and detecting a change in current characteristic of one or more opioid analytes in the sample.

In a further embodiment the method comprises the steps of providing a sample, contacting the sample electrically with a working electrode (2) and counter electrode (4) of an electrode assembly of a multilayer test strip according to any of the above described embodiments, changing voltage between the working electrode (2) and counter electrode (4) measuring a current between the working electrode (2) and counter electrode (4) in relation to the voltage applied between the working electrode (2) and counter electrode (4) and detecting a change in current characteristic of one or more opioid analytes in the sample.

In one embodiment the voltage between the working electrode (2) and counter electrode (4) is scanned from −0.6 V to 0.2 V. In a preferred embodiment the voltage between the working electrode (2) and counter electrode (4) is scanned from −0.5 V to 1.5 V.

In a further embodiment the scan rate is in the range of 2.5-40 mV/s.

In a further embodiment the method comprises the steps of providing a sample, contacting a test strip according to any of the embodiments described above with the sample provided, passing a current through the test strip and detecting a change in current characteristic of one or more opioid analytes in the sample.

### EXAMPLES

### SWCNT Synthesis

SWCNTs were synthesized by thermal decomposition of a floating ferrocene as catalyst in a carbon monoxide atmosphere. The process in described in greater detail in Kaskela et al (2010) and Moisala et al (2006). The SWCNTs form bundles in gas phase due to the surface energy minimization. The bundles are collected on nitrocellulose membranes (Millipore Ltd. HAWP, 0.45 μm pre size) from which they can be transferred onto other substrates.

### Electrode Fabrication

SWCNTNs were press transferred onto glass (Metzler) and densified. The room temperature press transfer process is described in greater detail in Kaskela et al (2010) and Iyer et al 2015. The glass was precut to 1 cm×2 cm pieces and cleaned by sonication in high performance liquid chromatography grade acetone (Sigma Aldrich). After cleaning, the pieces were blown by nitrogen and baked on a hotplate at 120° C. for a few minutes. The membrane filters with the SWCNTN were cut and placed on the glass pieces with the SWCNTN side down and pressed between two glass slides. After carefully peeling off the filter backing, the adhered SWCNTN was densified with a few drops of ethanol and baked at XX ° C. for xx min (FIG. 1a).

Silver contact pads were fabricated by conductive silver paint (Electrolube). The silver was dried at room temperature for 15 min and subsequently baked on a hotplate preheated to 60° C. for 3 min. Wires were contacted to the silver contact pads with silver epoxy (MG Chemicals) after which the epoxy was allowed to cure overnight (FIG. 1b). The electrode was covered with a PTFE film (Saint-Gobain Performance Plastics CHR 2255-2) with a 3 mm hole (FIG. 1c). Finally, the electrode was dip coated with Nafion. The electrode was immersed in 5 wt-% Nafion solution (Nafion 117 solution, Sigma Aldrich) for 5 s and allowed to dry in room air overnight (FIG. 1d).

### Characterization

### Electrochemistry

Cyclic voltammetry (CV) and differential pulse voltammetry (DPV) measurements were carried out with a CH Instruments (CHI630E) potentiostat. A three-electrode cell was used for all electrochemical measurements with an Ag/AgCl electrode as reference (+0.199 V vs SHE, Radiometer Analytical) and a graphitic rod as the counter electrode.

The electrochemical properties of SWCNTN and SWCNTN coated with Nafion were examined with four redox probes: FcMeOH, Ru(NH3)62+/3+, Fe(CN)64−/3− and IrCl62−. Solutions with a concentration of 1 mM solutions of each probe were prepared from ferrocenemethanol (Sigma-Aldrich) in 1 M KCl (Merck Suprapur) or in PBS, hexaammineruthenium(III)chloride (Sigma-Aldrich) in 1 M KCl or in PBS, potassium hexacyanoferrate(III) (Sigma-Aldrich) in 1 M KCl and potassium hexachloroiridate(IV) (Sigma-Aldrich) in 1 M KCl, respectively. The pH of PBS was 7.4 and . . . for KCl. Both electrode types were measured with each redox probe at room temperature at scan rates of 10, 25, 50, 100, 200, 300, 400, 500 and 1000 mV/s.

Stock solutions of 500 μM AA (L-Ascorbic acid, Sigma) and 500 μM UA (Uric acid, Sigma) were prepared by dissolving in PBS.

### MO & CO Solutions

The concentration series with MO and CO were conducted by injection method from 1 mM and 0.5 mM stock solutions. All DPV measurements were conducted at a scan rate of 50 mV/s. In all measurements, the solutions were deoxygenated with N2 for at least 5 minutes and the air was purged throughout the measurement.

### Results

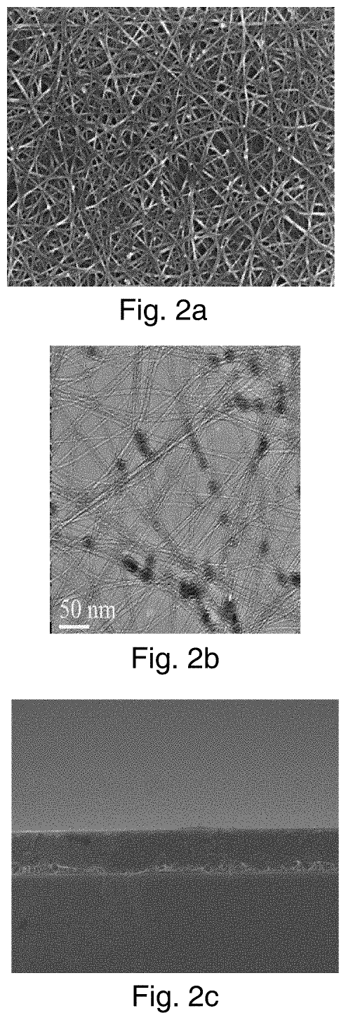

The press transferred and densified SWCNTN on silicon was imaged by SEM. A typical image is shown in Fig XX. The SWCNTN were also imaged with TEM shown in fig xx. Based on image analysis bundle diameters of 3 20 nm were found. The iron nanoparticles that form as a result of decomposition of the ferrocene catalyst appear dark in the bright field TEM image (see FIG. 2) and were found to be smaller than 50 nm. X-ray photoelectron spectroscopy (XPS) was also performed for the SWCNTN press transferred on oxidized silicon wafers was also carried out in prior work (Iyer et al (2015)). In the survey spectrum peaks for silicon, oxygen, and carbon were found. No significant peak for iron was detected.

### Image Analysis

The thickness of Nafion coating was analyzed from 121 SEM images over the full cross section. (FIG. 2). An average thickness of 1.17±0.54 μm was found. The large variation in the Nafion coating thickness is likely due to the deposition method. Drop coating is a very common method for coating electrodes.

### Raman Spectroscopy

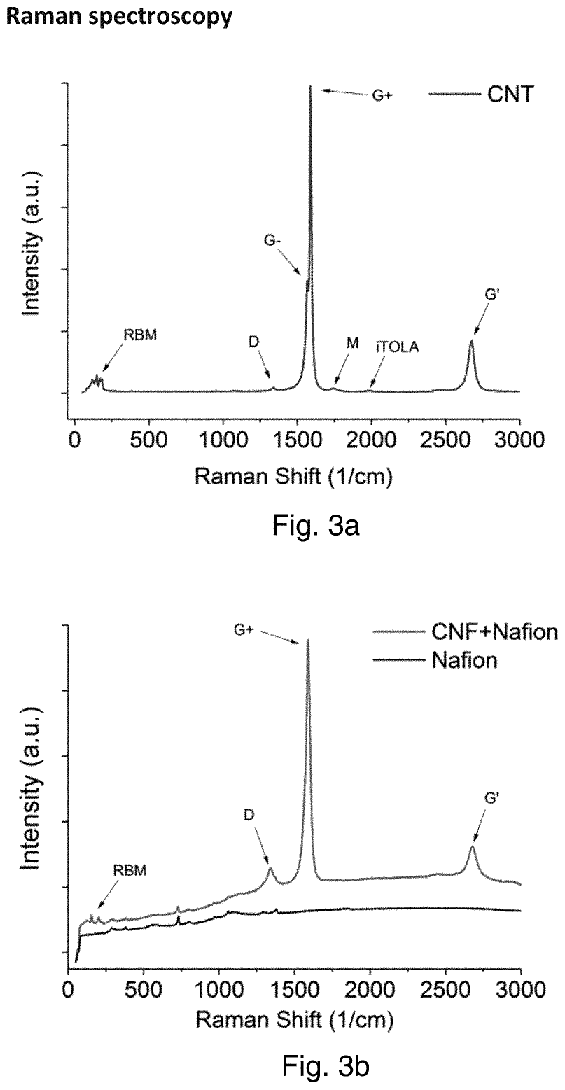

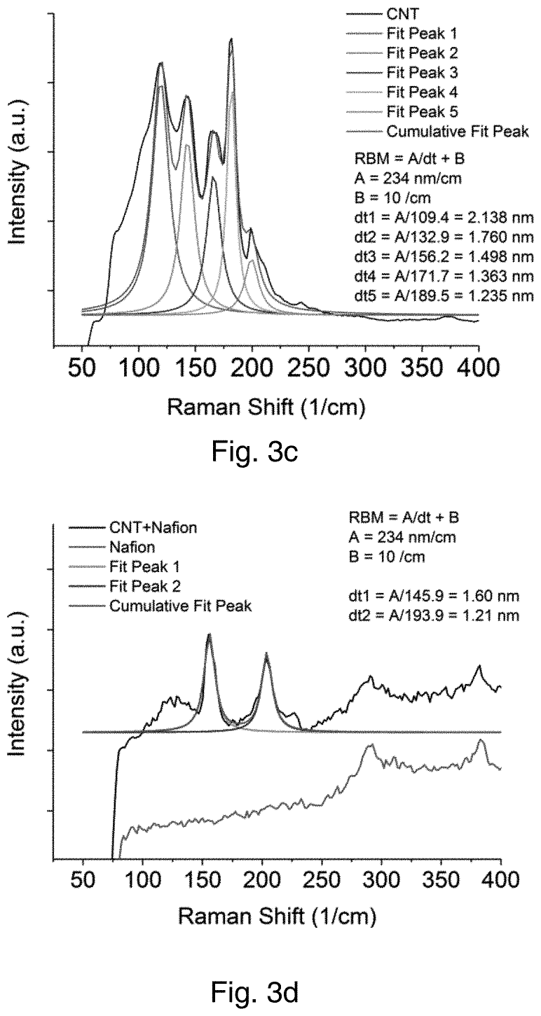

FIG. 3 shows the Ramanspectra of a) the pristine CNT network and b) the Nafion coated CNT network. The prominent peaks are marked in the figures. FIG. 3b) also shows spectra for a glass sample coated with Nafion. Several peaks including for CF₂, CS, COC, SO₃⁻ and CC were observed for the Nafion sample. All these peaks were also present in the Nafion coated CNT sample.

292 (CF₂ twisting), 307 (CF₂ twisting), 381 (CF₂ scissoring), 667 (CF₂ wagging) 725 (CF₂ symmetric stretch), 798 (CS stretch), 971 (COC symmetric stretch), 1059 (SO₃⁻ symmetric stretch), 1174 (SO₃⁻ degenerate stretch), 1207 (CF₂ degenerate stretch), 1291 (CC degenerate stretch) and 1372 (CC symmetric stretch) were observed for Nafion.

For the pristine tubes only a weak D peak is observed, indicating presence of only a small number of defects. The increase in the intensity and width of the peak around 1333 for the Nafion coated sample is likely at least partially due to overlap of the 1291 (CC degenerate stretch) and 1372 (CC symmetric stretch) observed for Nafion. Similar changes in the D/G-ratio have been observed for Nafion-CNT and PVDF-CNT composites. The CF₂ groups on the Nafion backbone are electron acceptors. Thus changes in the D/G-ratio are expected due to donor-acceptor interactions between the CNTs and fluorine at the interfaces that decrease in electron density of metallic CNTs. Moreover the sulfonic acid groups in the Nafion have been shown to be able to protonate SWCNTs.

This is reflected in the Raman spectra as a broadening and lowering in the intensity of the G⁻ peak. The changes in the G peak also contribute to the change in the D/G ratio.

Increase in metallicity does not lead to lower conductivity. P-doping shifts the Fermi level towards the valence band.

The appearance of RMB peaks indicates that all tubes are not totally coated with Nafion.

The radial breathing mode (RBM) peaks have been fitted with Lorentzian peaks and are shown in the insets. Equation (1) was used

$${ω}_{RBM} = ( \frac{A}{{d}_{t}} ) + B ,$$

where A=234 nm/cm and B=10 cm⁻¹.

Five RBM modes were found for the pristine CNT sample, whereas only two clear modes were observed for the nafion coated sample.

### Electrochemistry

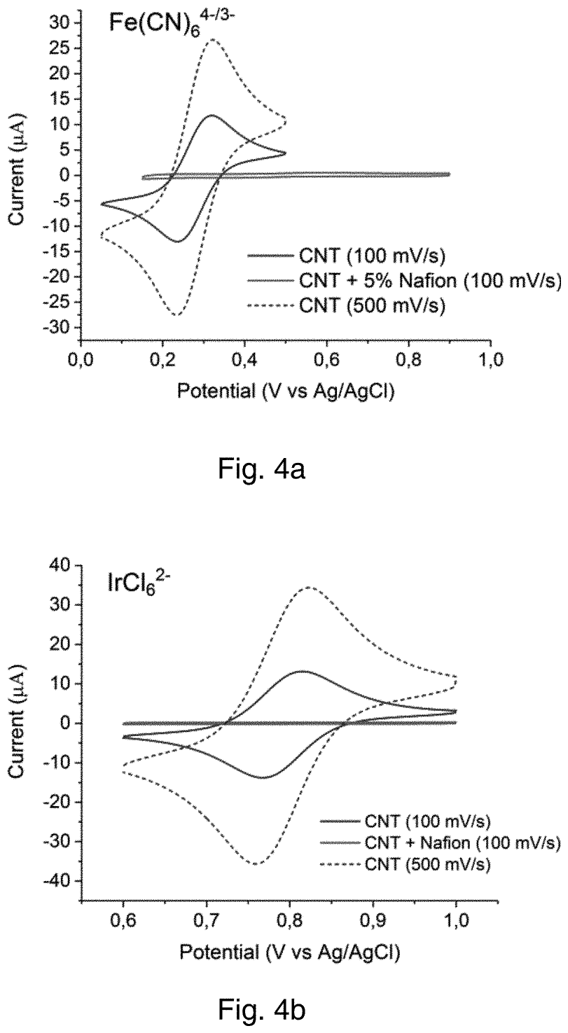

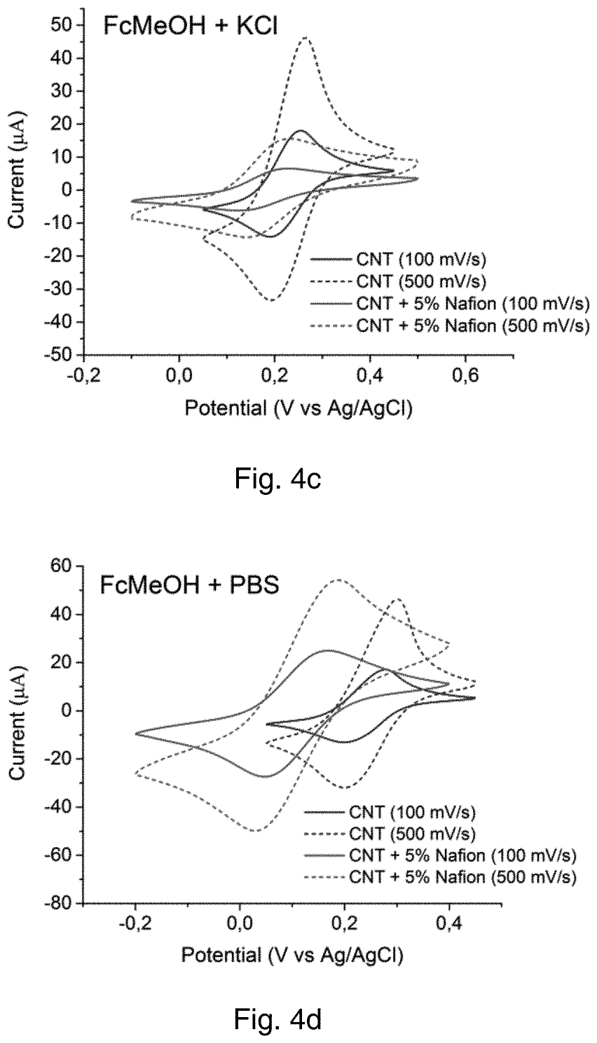

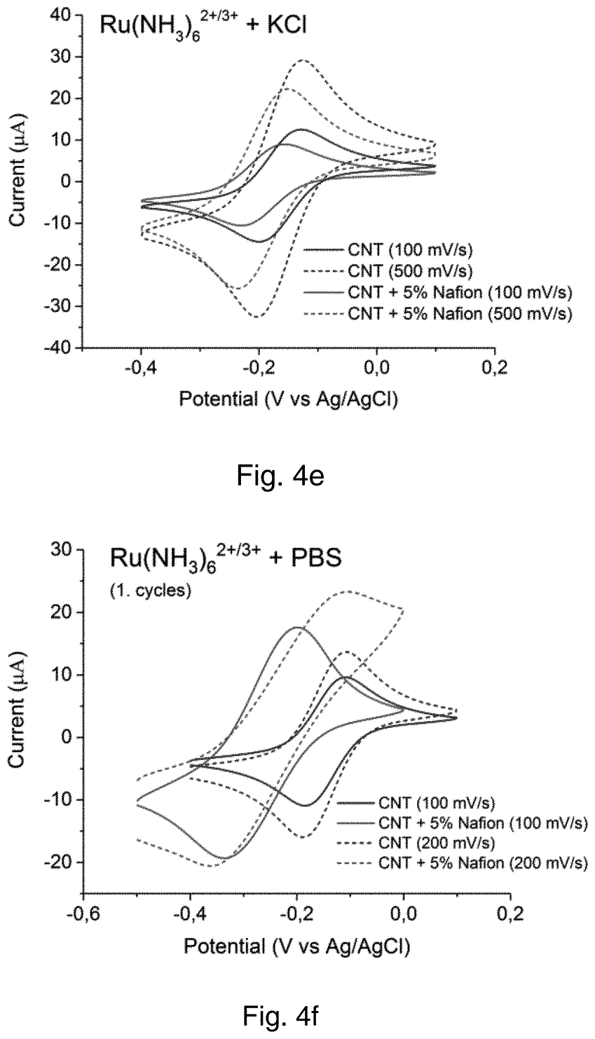

Several known redox systems, including FcMeOH, Ru(NH₃)₆^{2+/3+}, Fe(CN)₆^{4-/3-}, IrCl₆²⁻, were used to study the electrochemical properties of the SWCNT and Nafion coated SWCNT electrodes. Among these Ru(NH₃)₆^{2+/3+} is considered to be an outer sphere redox system, whose electron transfer is independent of surface chemistry. FcMeOH is also often regarded as an outer sphere system, but it has been reported that it may adsorb to carbon electrodes. The charge of the redox probes can be seen to affect the permeability through the Nafion coating. The electron transfer of the negatively charged Fe(CN)₆^{4-/3-} and IrCl₆²⁻ is almost totally suppressed for the former and totally suppressed for the latter. A drop in the current was observed for the Nafion coated electrode with Ru(NH₃)₆^{2+/3+}, whereas increase in current was observed with FcMeOH. To verify that the observed behavior is not related to variations in electrodes one of each electrodes was measured first in Ru(NH₃)₆^{2+/3+} and then in FcMeOH. Similar oxidation and reduction currents and peak potential separation was observed in both cases. (FIG. 4)

It is likely that the diffusion of Ru(NH₃)₆^{2+/3+} is slow due to considerable electrostatic interaction of the counter ion to Nafion. Et al. showed that Ru(NH₃)₆²⁺ has very high affinity to Nafion. Moreover the structure of Nafion contains large unsulfonated. Szentimary et al. suggested that the un-sulfonated regions allows for hydrophobic interactions that drive the ion exchange reactions of organic cations. As FcMeOH is a hydrophobic molecule with much lower solubility than that of Ru(NH₃)₆ such hydrophobic interactions may explain the observed behavior.

The shifts observed in the formal potential of FcMeOH and Ru(NH₃)₆^{2+/3+} are known to occur for redox active probes incorporated into nafion membranes. The magnitude of shift depends on the ionic strength of the supporting electrolyte. FcMeOH and Ru(NH₃)₆^{2+/3+} must be measured with the same electrodes to ensure that the observed difference is not batch to batch variation, but that the difference is due to properties of the molecules. Table 1 shows the peak potential separation (ΔEp), Oxidation and reduction currents of the used redox probes at the CNT and the nafion coated CNT electrode.

TABLE 1
peak potential separation (ΔEp), Oxidation and reduction currents
of the used redox probes at the CNT and the nafion coated CNT electrod

| | | | | | | |
|---|---|---|---|---|---|---|
| | ΔEp (mV), | Iₚₐ (μA) | I_{pc} (μA) | ΔEp (mV), | Iₚₐ (μA) | I_{pc} (μA) |
| Electrode | 100 mV/s | 100 mV/s | 100 mV/s | 500 mV/s | 500 mV/s | 500 mV/s |

Ru(NH₃)₆^{2+/3+} (in KCl)

| | | | | | | |
|---|---|---|---|---|---|---|
| CNT | 73.1 ± 3.7 | −13.0 ± 0.002 | 12.0 ± 0.002 | 83.9 ± 6.3 | −29.8 ± 0.003 | 26.8 ± 0.004 |
| CNT-Nafion | 70.7 ± 2.2 | −11.3 ± 0.0009 | 9.2 ± 0.0008 | 81.5 ± 4.3 | −26.4 ± 0.001 | 21.8 ± 0.001 |

FcMeOH (in PBS)

| | | | | | | |
|---|---|---|---|---|---|---|
| CNT | 73.2 ± 2.9 | −13.4 ± 0.0006 | 15.8 ± 0.0008 | 93.6 ± 4.3 | −30.4 ± 0.0009 | 42.1 ± 0.0008 |
| CNT-Nafion | 142.9 ± 16.3 | −24.1 ± 0.004 | 23.2 ± 0.004 | 171.8 ± 9.3 | −38.1 ± 0.008 | 47.6 ± 0.007 |

Fe(CN)₆^{4-/3-}

| | |
|---|---|
| CNT | One measurement still missing with CNT |
| CNT-Nafion | No peaks with Nafion |

IrCl₆²⁻

| | | | | | | |
|---|---|---|---|---|---|---|
| CNT | 51.0 ± 9.6 | −11.0 ± 0.003 | 10.6 ± 0.003 | 68.0 ± 3.8 | −27.9 ± 0.008 | 26.1 ± 0.008 |

| | |
|---|---|
| CNT-Nafion | No peaks with Nafion |

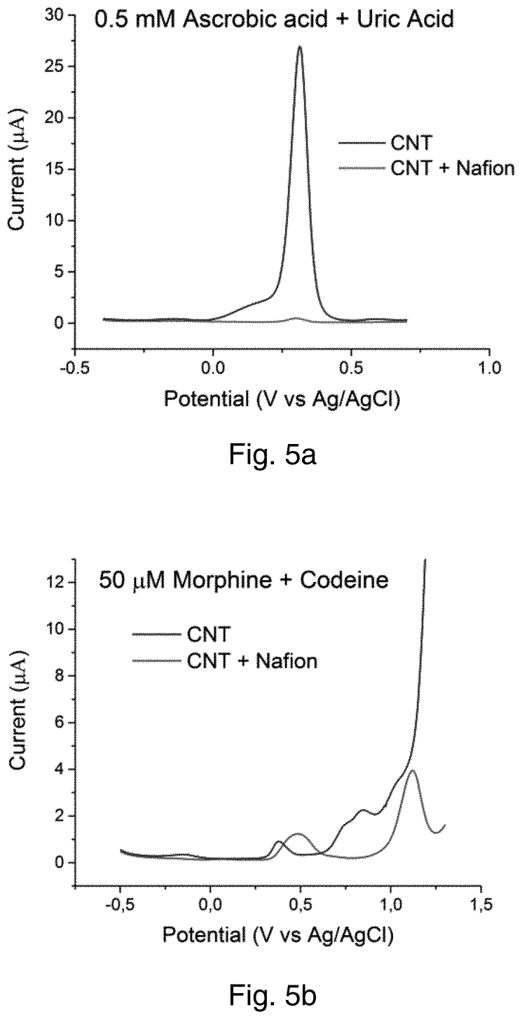

In CV experiments the AA and UA signal can be totally suppressed with Nafion coating. With slower DPV, total suppression, especially of UA, is much more challenging. FIG. 5a) shows total suppression of AA and 98.2% suppression in UA signal.

FIG. 5b) shows the DPV of 50 μM MO and CO solution. First it is important to note that both MO and CO show several oxidation peaks at the CNT electrode. At the Nafion coated electrode only one peak for each electrode can be observed. The oxidation currents are also increased, likely due to pre-concentration.

To establish individual pharmacokinetic and pharmacogenetics factors it is important to be able to simultaneously quantitatively measure the blood concentration of morphine and codeine of a patient. Especially morphine has to be measured accurately. The electrode utilized in this work can be seen to repeatably measure currents for 50 nM morphine in the presence of AA, UA and CO. Produces two linear ranges. The lower range is well within the therapeutic concentrations for treatment of pain and also for most cases of intoxication, and poisoning.

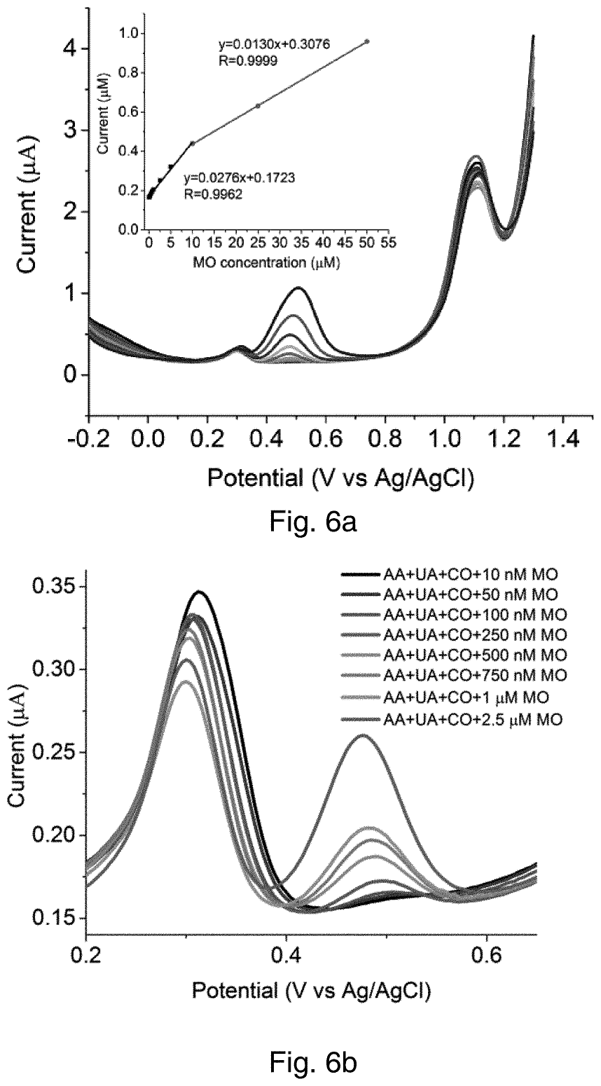

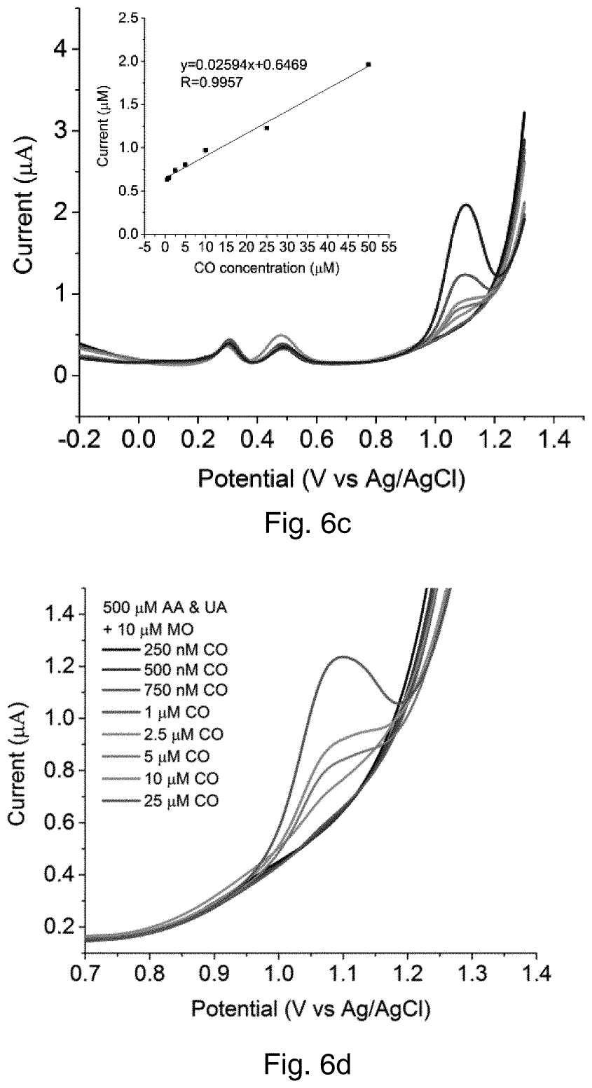

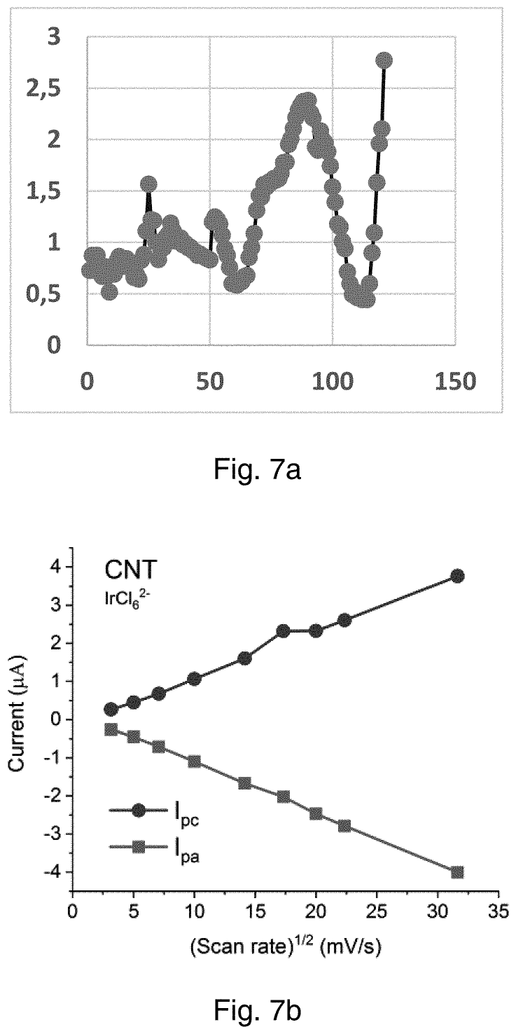

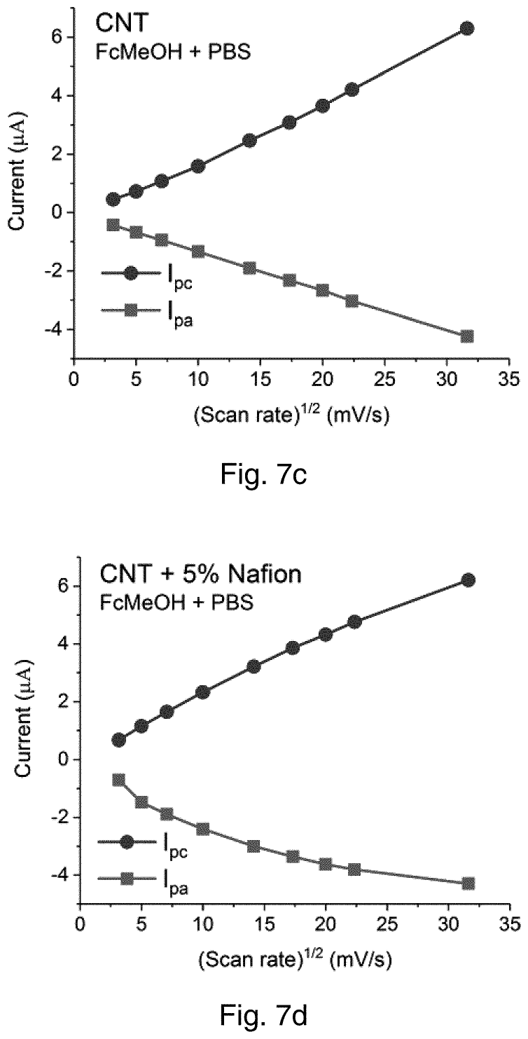

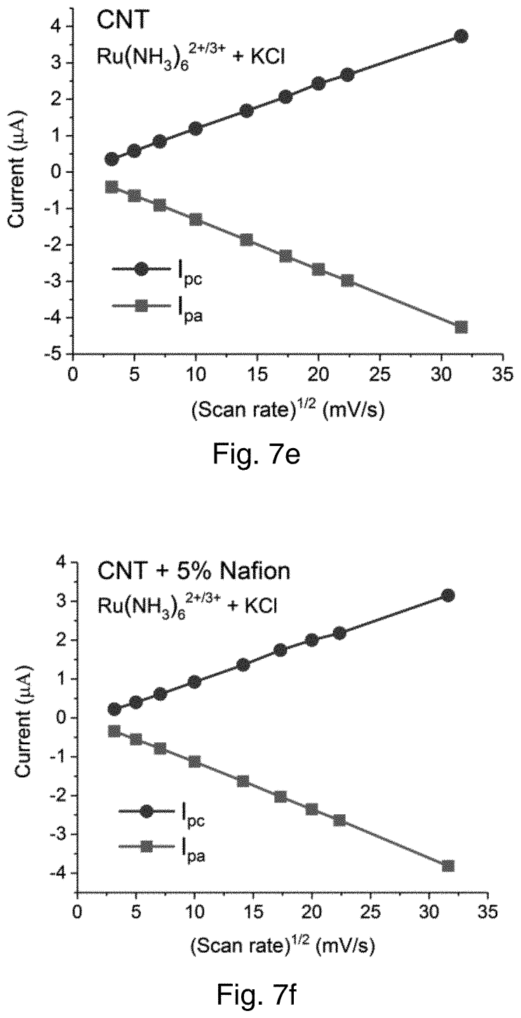

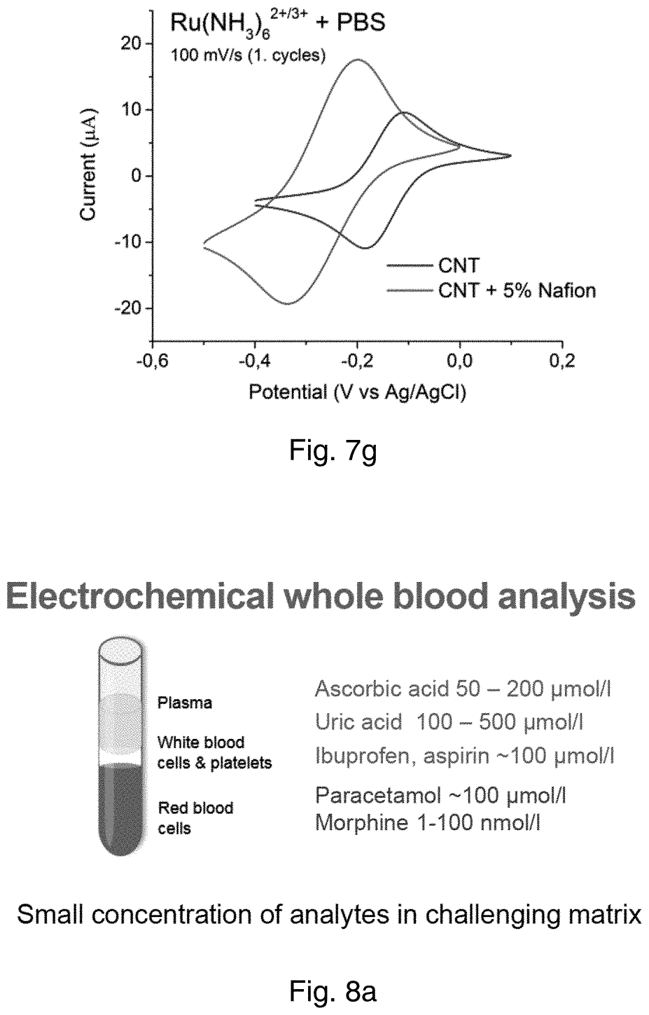

FIG. 6 shows differential pulse voltammograms for pristine and Nafion coated SWCNTN electrodes in 500 μM AA, 500 μM UA and c) 10 μM CO with increasing concentration of MO from 10 nM to 2.5 μM and d) 10 μM MO with increasing concentration of CO from 10 nM to 2.5 μM. Scan rate 50 mV/s.

The low background current observed with this electrode significantly increases the signal to noise ratio. The overlapping second oxidation peak of morphine makes quantitation of heroin and codeine more challenging. The electrode used in the present work gives a clear advantage as both molecules only give rise to one peak each that can be clearly distinguished.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

At least some embodiments of the present invention find industrial application in various areas of healthcare. Embodiments provide a simple, inexpensive real-time method for quantitative measurement of opioid serum concentrations may facilitate personal opioid therapy and differential diagnosis in acute care. The invention may also significantly reduce costs in clinical research, especially in large population level pharmacokinetic studies. With current demographic development the age of the population is expected to grow in the coming decades. This will put a huge strain on already struggling healthcare systems. Especially in the US, where most opioids are prescribed and consumed, there is enormous pressure on the health care system to cut cost.

What is claimed is:

1. A multilayer test strip comprising a substrate onto which is deposited an electrode assembly layer comprising
a carbon-based working electrode,
a carbon-based counter electrode,
a pseudoreference electrode, wherein the pseudo reference electrode, the working electrode and the counter electrode, are arranged adjacent to each other in the same plane,
contacts for contacting the electrodes directly to a voltage supply, and
the test strip further comprises a permselective membrane layer,
said electrodes of the electrode assembly layer being electrically separated from one another and said electrode assembly layer being positioned between the substrate and the permselective membrane layer.

2. The strip according to claim 1, wherein the carbon-based electrode comprises carbon selected from the group consisting of amorphous carbon, such as tetrahedral amorphous carbon, diamond like carbon, graphite, carbon nanotubes and a mixture thereof.

3. The strip according to claim 1, wherein the substrate is selected from the group consisting of polymer and glass.

4. The strip according to claim 1, wherein the working electrode or counter electrode, or both the working electrode and the counter electrode further comprises titanium.

5. The strip according to claim 1, wherein the pseudo reference electrode comprises silver.

6. The strip according to claim 1, wherein the pseudo reference electrode comprises silver-silver chloride (Ag/AgCl).

7. The strip according to claim 1, wherein the pseudo reference electrode comprises platinum.

8. The strip according to claim 1, wherein the contacts comprise silver.

9. The strip according to claim 1, wherein the permselective membrane layer comprises a cation permselective membrane selected from the group of polymers consisting of Nafion, cellulose acetate, conventional dialysis membranes, polyvinyl sulfonate, carboxymethyl cellulose, polylysine, overoxidised polypyrrole and other sulfonated polymers.

10. The strip according to claim 1, wherein the permselective membrane layer comprises Nafion.

11. The strip according to claim 1 further comprising a filter layer, wherein the strip is arranged so that the permselective membrane layer is positioned between the filter layer and the electrode assembly layer.

12. The strip according to claim 11 further comprising a hydrophobic membrane/film layer, wherein the strip is arranged so that the filter layer is positioned between the permselective membrane layer and the hydrophobic membrane/film layer.

13. An apparatus comprising:
a memory configured to store reference data;
at least one processing core configured to:
process information from the strip according to claim 1;
compare the information from the strip according to claim 1 to the reference data, and
draw conclusions on the information processed from the strip according to claim 1.

14. A method for the detecting opioids in a sample comprising the steps of
providing a sample,
contacting the sample electrically with a working electrode and counter electrode of an electrode assembly of a multilayer test strip,
changing voltage between the working electrode and counter electrode
measuring a current between the working electrode and counter electrode in relation to the voltage applied between the working electrode and counter electrode and
detecting a change in current characteristic of one or more opioid analytes in the sample.

15. The method for detecting opioids in a sample comprising the steps of
providing a sample,
contacting the sample electrically with a working electrode and counter electrode of an electrode assembly of a multilayer test strip according to claim 1,
changing voltage between the working electrode and counter electrode
measuring a current between the working electrode and counter electrode in relation to the voltage applied between the working electrode and counter electrode and
detecting a change in current characteristic of one or more opioid analytes in the sample.

16. The method in accordance with claim 14 wherein the voltage between the working electrode and counter electrode is scanned from −0.6 V to 0.2 V.

17. The method in accordance with claim 14 wherein the voltage between the working electrode and counter electrode is scanned from −0.5 V to 1.5 V.

18. The method in accordance with claim 14 wherein the scan rate is in the range of 2.5-40 mV/s.

19. The strip according to claim 2, wherein the substrate is selected from the group consisting of polymer and glass.

20. The strip according to claim 2, wherein the working electrode or counter electrode, or both the working electrode and the counter electrode further comprises titanium.
